(19) United States
(12) Patent Application Publication
(10) Pub. No.: US 2016/0092644 A1
(43) Pub. Date: Mar. 31, 2016

(54) DIAGNOSIS SUPPORT PROGRAM DEVELOPMENT PROMOTING APPARATUS, OPERATION METHOD AND OPERATION PROGRAM FOR DIAGNOSIS SUPPORT PROGRAM DEVELOPMENT PROMOTING APPARATUS, AND DIAGNOSIS SUPPORT PROGRAM DEVELOPMENT PROMOTING SYSTEM

(71) Applicant: FUJIFILM Corporation, TOKYO (JP)

(72) Inventor: FUMITAKE TANAKA, KANAGAWA (JP)

(73) Assignee: FUJIFILM Corporation, TOKYO (JP)

(21) Appl. No.: 14/849,609

(22) Filed: Sep. 10, 2015

(30) Foreign Application Priority Data
Sep. 29, 2014 (JP) 2014-199347

(51) Int. Cl. G06F 19/00

(52) U.S. Cl. CPC G06F 19/345; G06F 19/322; G06F 19/3431

(57) ABSTRACT

Provided are a diagnosis support program development promoting apparatus, an operation method and operation program for the diagnosis support program development promoting apparatus, and a diagnosis support program development promoting system, capable of promoting development of a diagnosis support program while protecting privacy of a medical facility. An information collecting unit collects actual usage situation information of a diagnosis support program, and facility information of a medical facility. A concealment unit conceals facility specifying information for specifying the medical facility in the facility information of the medical facility. An information providing unit provides development reference information including the actual usage situation information and the facility information in which the facility specifying information is concealed, in response to an information providing request from a vendor or the like.

### CROSS-REFERENCE TO RELATED APPLICATIONS

The present application claims priority under 35 U.S.C. §119 to Japanese Patent Application No. 2014-199347, filed on Sep. 29, 2014, all of which are hereby expressly incorporated by reference into the present application.

### BACKGROUND OF THE INVENTION

1. Field of the Invention

The present invention relates to a diagnosis support program development promoting apparatus, an operation method and operation program for the diagnosis support program development promoting apparatus, and a diagnosis support program development promoting system.

2. Description of the Related Art

A diagnosis support program has been recently used in a medical field. The diagnosis support program performs calculation by using medical examination data such as test data or measurement data acquired during medical examination of a patient as input data, and outputs a calculation result as diagnosis support information for supporting a diagnosis related to the patient. Specifically, the diagnosis support program includes a program which outputs a size or the type of lesion in a test image as diagnosis support information by using the test image obtained through various image tests as input data, or a program which outputs the presence or absence of side effects due to medication as diagnosis support information by using measured values of vital signs such as a heart rate, a pulse, blood pressure, and a body temperature of a patient as input data.

JP2005-004780A discloses a medical examination support system including a facility terminal (diagnosis support executing terminal) which is used by doctors in a medical facility, a center server (diagnosis support content server) which stores and collectively manages a plurality of diagnosis support programs (diagnosis support content items) developed by a vendor such as a research institution or a company and selectively delivers a diagnosis support program corresponding to a delivery request from the facility terminal, and a network which connects the facility terminal and the center server to each other in a communicable manner.

JP2005-004780A also discloses an embodiment (second embodiment) in which a creation tool of a diagnosis support program is provided to vendors so that an unspecified large number of vendors can freely develop a diagnosis support program, and the diagnosis support program is created by using the tool.

### SUMMARY OF THE INVENTION

Recently, in the medical field, the progress of medical research or the innovation of medical technologies such as development of new drugs or establishment of new findings has been remarkable, and a large volume of various information has been collected with the advance of information technologies so that so-called big data has had to be integrated. For adaptation to such a trend, various types of diagnosis support programs are also expected to be developed by vendors in the future.

Since increases in medical expenses due to the aging of patients have become a serious problem worldwide, it is desirable that all of society including the vendors increases development efficiency of a diagnosis support program through cooperation with each other and thus the development of the diagnosis support program is promoted.

If the development of a diagnosis support program is to be further promoted on the basis of such a situation, it is not sufficient to only provide the diagnosis support program creation tool to an unspecified large number of vendors as in JP2005-004780A. This is because, if a diagnosis support program is only created blindly in a state in which functions and quality of a diagnosis support program required by a medical facility, that is, needs of the medical facility for the diagnosis support program are not understood, this means just an increase in the number of diagnosis support programs which are not useful as products.

Therefore, in order to understand the needs, interviews may be repeatedly performed between a vendor and the medical facility. However, the interviews require effort and time and thus reduce the development efficiency of a diagnosis support program and impede promotion of the development. In addition, since dealing with a vendor is troublesome in the medical facility, interviews are not realistic in consideration of a busy situation in the medical facility.

However, if the vendor knows in what kind of medical facility a diagnosis support program is used and how to use the diagnosis support program, that is, information regarding a medical facility (facility information) and information regarding an actual usage situation of the diagnosis support program (actual usage situation information) even when the needs cannot be directly understood, the vendor can indirectly understand the needs on the basis of such information.

Therefore, development reference information which allows the needs to be indirectly understood by collecting the facility information and the actual usage situation information by using a computer may be provided to the vendor. However, since the facility information includes facility specifying information for specifying a medical facility, if the facility specifying information is also provided, there is a problem in that a busy medical facility may be brought into the undesirable state of having to receive inquiries from vendors.

An object of the present invention is to provide a diagnosis support program development promoting apparatus, an operation method and an operation program for the diagnosis support program development promoting apparatus, and a diagnosis support program development promoting system, capable of promoting development of a diagnosis support program while protecting privacy of a medical facility.

In order to solve the problem described above, according to an aspect of the invention, there is provided a diagnosis support program development promoting apparatus for promoting development of a diagnosis support program which outputs diagnosis support information by using medical examination data of a patient, the apparatus including: an information collecting unit that collects actual usage situation information regarding an actual usage situation of the diagnosis support program in a medical facility, and facility information regarding the medical facility, including facility specifying information for specifying the medical facility, for each medical facility; a concealment unit that conceals the facility specifying information; and an information providing unit that provides development reference information including the actual usage situation information and the facility information in which the facility specifying information is concealed, in response to an information providing request.

The actual usage situation information preferably includes at least one of a usage frequency, a purpose of use, and usage performance of the diagnosis support program, and a medical department using the diagnosis support program, and a disease for which the diagnosis support program is used.

The facility information preferably includes at least one of a size of the medical facility, a medical department provided in the medical facility, an area in which the medical facility is present, diseases treated in the medical facility, and treatment results of the medical facility based on the number of patients treated in the medical facility.

The treatment result preferably includes at least one of the monthly average number of patients of the medical facility, area share indicating a proportion of the number of patients treated in the medical facility in the area in which the medical facility is present, the average number of disease-based hospitalization days of the medical facility, and the number of treatment period-based patients of the medical facility.

Preferably, the facility information includes a name of the medical facility, and the facility specifying information is at least the name. The facility specifying information may be not only the medical facility name but also an address and a telephone number of the medical facility, and a name and a picture of an appearance of a doctor of the medical facility.

Preferably, the diagnosis support program development promoting apparatus further includes a statistical processing unit that performs a statistical process on the actual usage situation information and the facility information to output statistical information, and the information providing unit provides the statistical information as the development reference information. The statistical information preferably includes trend information indicating trends in actual usage situations of the diagnosis support program in a plurality of medical facilities. The trend information preferably includes time-series data indicating temporal changes in the trends.

The statistical processing unit preferably performs a sorting process of sorting the actual usage situation information and the facility information, or the trend information on the basis of diseases or/and areas, as the statistical process, and outputs the information having undergone the sorting process as the statistical information.

The trend information preferably includes at least one of a competition index calculated by dividing the number of patients by the number of diagnosis support programs or/and a penetration rate calculated by dividing the number of diagnosis support programs by the number of patients, the number of introduction results of the diagnosis support program, and a usage ratio of the diagnosis support program of the medical facility in which treatment result is higher than a predefined level.

The diagnosis support program development promoting apparatus preferably further includes an expression standardizing unit that unifies expressions of terms used in the actual usage situation information and the facility information into a standard expression which is registered in advance.

The information providing unit preferably provides the development reference information in response to the information providing request from a vendor of the diagnosis support program. The information providing unit preferably provides the development reference information in response to the information providing request from the medical facility.

The information collecting unit preferably acquires the actual usage situation information which is automatically transmitted from a transmission source.

The information collecting unit preferably acquires the actual usage situation information which is manually transmitted from a transmission source. In this case, the diagnosis support program development promoting apparatus preferably further includes a provision determination unit that determines whether or not the development reference information will be provided to the transmission source depending on a collection situation of the actual usage situation information in the information collecting unit. The provision determination unit preferably determines that the development reference information will not be provided to the transmission source which has not transmitted the actual usage situation information for a predetermined period of time.

Preferably, the transmission source is a facility terminal which uses the diagnosis support program in the medical facility, or a program function providing server which receives input data from the facility terminal, causes the diagnosis support program to perform calculation on the basis of the received input data, and transmits the diagnosis support information which is output as a result of the calculation to the facility terminal.

According to another aspect of the invention, there is provided an operation method for a diagnosis support program development promoting apparatus for promoting development of a diagnosis support program which outputs diagnosis support information by using medical examination data of a patient, the method including: an information collecting step of collecting actual usage situation information regarding an actual usage situation of the diagnosis support program in a medical facility, and facility information regarding the medical facility, including facility specifying information for specifying the medical facility, for each medical facility; a concealment step of concealing the facility specifying information; and an information providing step of providing development reference information including the actual usage situation information and the facility information in which the facility specifying information is concealed, in response to an information providing request.

According to still another aspect of the invention, there is provided an operation program for a diagnosis support program development promoting apparatus for promoting development of a diagnosis support program which outputs diagnosis support information by using medical examination data of a patient, the program causing a computer to execute: an information collecting function of collecting actual usage situation information regarding an actual usage situation of the diagnosis support program in a medical facility, and facility information regarding the medical facility, including facility specifying information for specifying the medical facility, for each medical facility; a concealment function of concealing the facility specifying information; and an information providing function of providing development reference information including the actual usage situation information and the facility information in which the facility specifying information is concealed, in response to an information providing request.

According to still another aspect of the invention, there is provided a diagnosis support program development promoting system including: a diagnosis support program development promoting server that promotes development of a diagnosis support program which outputs diagnosis support information by using medical examination data of a patient; a facility terminal of a medical facility that uses the diagnosis support program; and a network that connects the diagnosis support program development promoting server to the facility terminal in a communicable manner, in which the diagnosis support program development promoting server includes an information collecting unit that collects actual usage situation information regarding an actual usage situation of the diagnosis support program in the medical facility, and facility information regarding the medical facility, including facility specifying information for specifying the medical facility, for each medical facility; a concealment unit that conceals the facility specifying information; and an information providing unit that provides development reference information including the actual usage situation information and the facility information in which the facility specifying information is concealed, in response to an information providing request.

Preferably, the diagnosis support program is downloaded to the facility terminal, and the actual usage situation information is transmitted from the facility terminal to the diagnosis support program development promoting server.

Alternatively, preferably, the diagnosis support program development promoting system further includes a program function providing server that receives input data from the facility terminal, causes the diagnosis support program to perform calculation on the basis of the received input data, and transmits the diagnosis support information which is output as a result of the calculation to the facility terminal, and the actual usage situation information is transmitted from the program function providing server to the diagnosis support program development promoting server.

According to the present invention, since facility specifying information for specifying a medical facility is concealed in a case where development reference information including actual usage situation information and facility information is provided in response to an information providing request, it is possible to provide a diagnosis support program development promoting apparatus, an operation method and operation program for the diagnosis support program development promoting apparatus, and a diagnosis support program development promoting system, capable of promoting development of a diagnosis support program while protecting privacy of the medical facility.

### BRIEF DESCRIPTION OF THE DRAWINGS

FIG. 1 is a diagram illustrating a medical examination support system.

FIG. 2 is a diagram illustrating transmission and reception of various information pieces between a center server, a facility terminal, and a vendor terminal.

FIG. 3 is a diagram illustrating a DB group of a data center.

FIG. 4 is a diagram illustrating the content of a program list.

FIG. 5 is a diagram illustrating the content of a facility information list.

FIG. 6 is a diagram illustrating the content of an actual usage situation information list.

FIG. 7 is a diagram illustrating the content of a vendor information list.

FIG. 8 is a block diagram illustrating a computer which constitutes each of the center server, the facility terminal, and the vendor terminal.

FIG. 9 is a block diagram illustrating functional units of a CPU of the facility terminal.

FIG. 10 is a diagram illustrating a medical examination data display screen.

FIG. 11 is a diagram illustrating a display aspect of diagnosis support information.

FIG. 12 is a block diagram illustrating functional units of a CPU of the vendor terminal.

FIG. 13 is a diagram illustrating an initial screen of a development reference information display screen.

FIG. 14 is a diagram illustrating the development reference information display screen on which actual usage situation information is displayed.

FIG. 15 is a diagram illustrating a facility information display screen.

FIG. 16 is a block diagram illustrating functional units of a CPU of a center server.

FIG. 17 is a block diagram illustrating details of an information providing unit.

FIG. 18 is a flowchart illustrating an operation procedure of the functional units of the CPU of the center server.

FIG. 19 is a diagram illustrating treatment results of a medical facility.

FIG. 20 is a diagram illustrating usage performance of a diagnosis support program.

FIG. 21 is a diagram illustrating a competition index and a penetration rate of the diagnosis support program based on diseases.

FIG. 22 is a diagram illustrating a competition index and a penetration rate of the diagnosis support program based on areas.

FIG. 23 is a diagram illustrating the number of introduction results of the diagnosis support program.

FIG. 24 is a diagram illustrating a usage ratio of the diagnosis support program.

FIG. 25 is a diagram illustrating time-series data of the competition index of the diagnosis support program based on diseases.

FIG. 26 is a diagram illustrating a second embodiment in which an expression standardizing unit is provided which unifies expressions of terms used in actual usage situation information and facility information into a standard expression which is registered in advance.

FIG. 27 is a diagram illustrating a case where the development reference information is provided to the medical facility.

FIG. 28 is a diagram illustrating an aspect of using a program function providing server which provides a function of the diagnosis support program to the facility terminal.

FIG. 29 is a diagram illustrating a third embodiment in which a provision determination unit is provided which determines whether or not development reference information will be provided to a transmission source of the actual usage situation information.

### DESCRIPTION OF THE PREFERRED EMBODIMENTS

### First Embodiment

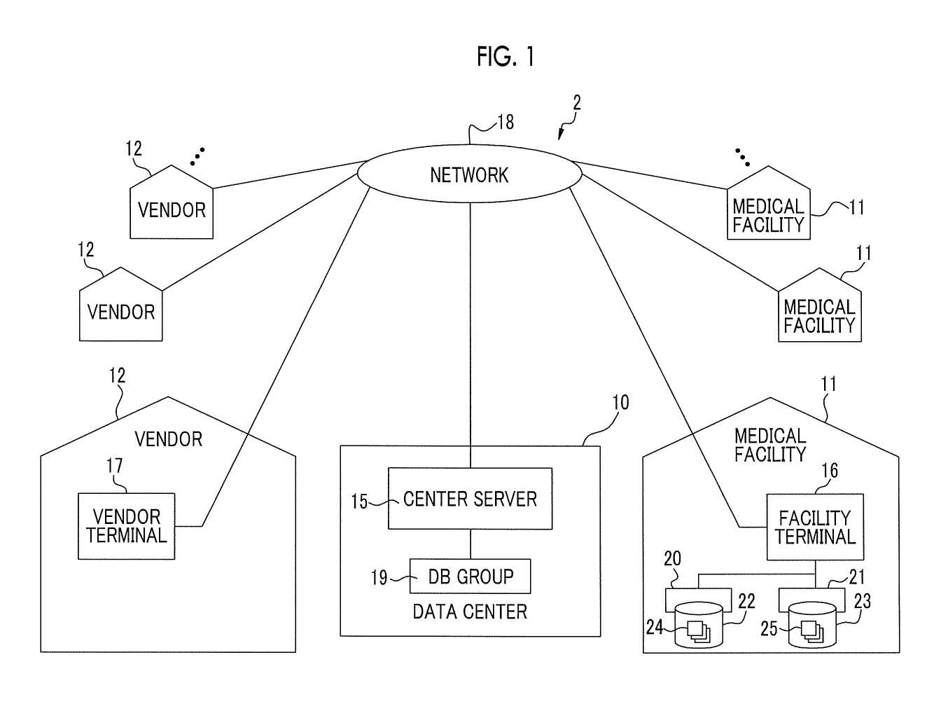

In FIG. 1, a medical examination support system 2 includes a center server 15 provided in a data center 10, a facility terminal 16 provided in a medical facility 11, and a network 18 which connects the above-described elements to each other in a communicable manner. The medical examination support system 2 corresponds to a diagnosis support program development promoting system of the present invention.

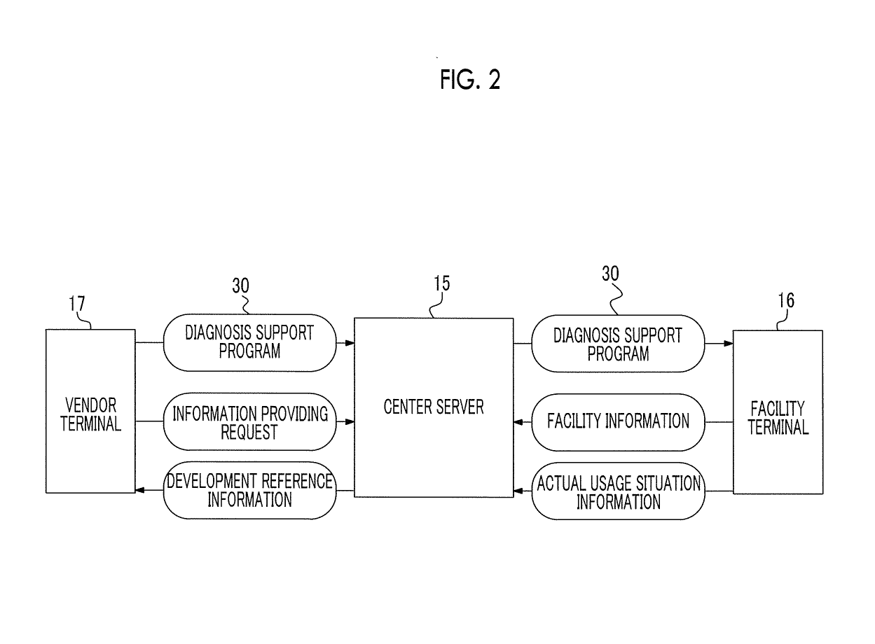

The medical facility 11 is a user of a diagnosis support program 30 (refer to FIG. 2), and a vendor 12 is a source which creates and develops the diagnosis support program 30. A vendor terminal 17 provided in the vendor 12 is connected to the center server 15 so as to communicate therewith via the network 18.

The facility terminal 16 is operated by a doctor of the medical facility 11 during diagnosis or the like using the diagnosis support program 30. The vendor terminal 17 is operated by a developer of the vendor 12 during development or the like of the diagnosis support program 30. The center server 15 corresponds to a diagnosis support program development promoting apparatus and a diagnosis support program development promoting server of the present invention.

The data center 10 provides various application services such as a sales mediation service of the diagnosis support program 30 between the medical facility 11 and the vendor 12, or a service of providing information such as development reference information (refer to FIG. 2 and the like) for understanding the needs of the medical facility 11 for the diagnosis support program 30 to the vendor 12. The medical facility 11 and the vendor 12 make a contract with the data center 10 in order to receive the various application services, and are registered in the data center 10 as users who use the various application services.

The network 18 is a closed network which uses a dedicated wide internet protocol (IP) network owned by a communication provider as a base network and in which a virtual private network (VPN) is built into the wide IP network. Various information pieces which are transmitted and received in the network 18 do not leak to the outside of the medical examination support system 2 thanks to the VPN, and the security of the various information pieces is ensured.

A database (hereinafter, abbreviated to DB) group 19 is provided in the data center 10. An electronic medical chart server 20 and an image server 21 are provided in the medical facility 11. The center server 15, the DB group 19, and the facility terminal 16, the electronic medical chart server 20 and the image server 21 are connected to each other in a communicable manner, via networks such as a local area network (LAN).

An electronic medical chart DB 22 is built into the electronic medical chart server 20, and an image DB 23 is built into the image server 21. An electronic medical chart 24 is stored in the electronic medical chart DB 22, and a test image 25 is stored in the image DB 23 as medical examination data. The image server 21 is a so-called picture archiving and communication system (PACS) server.

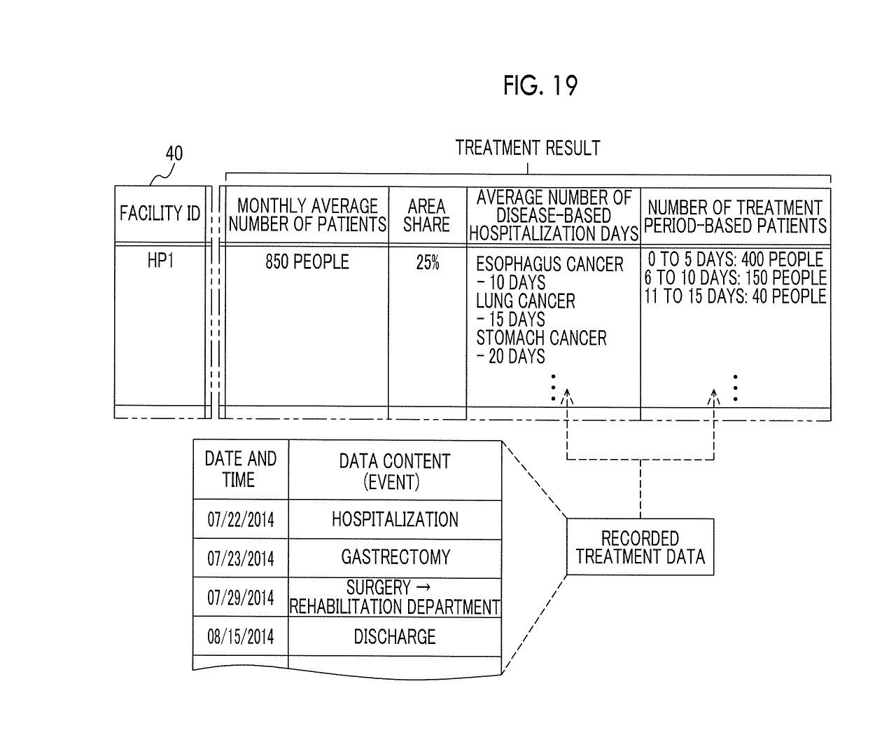

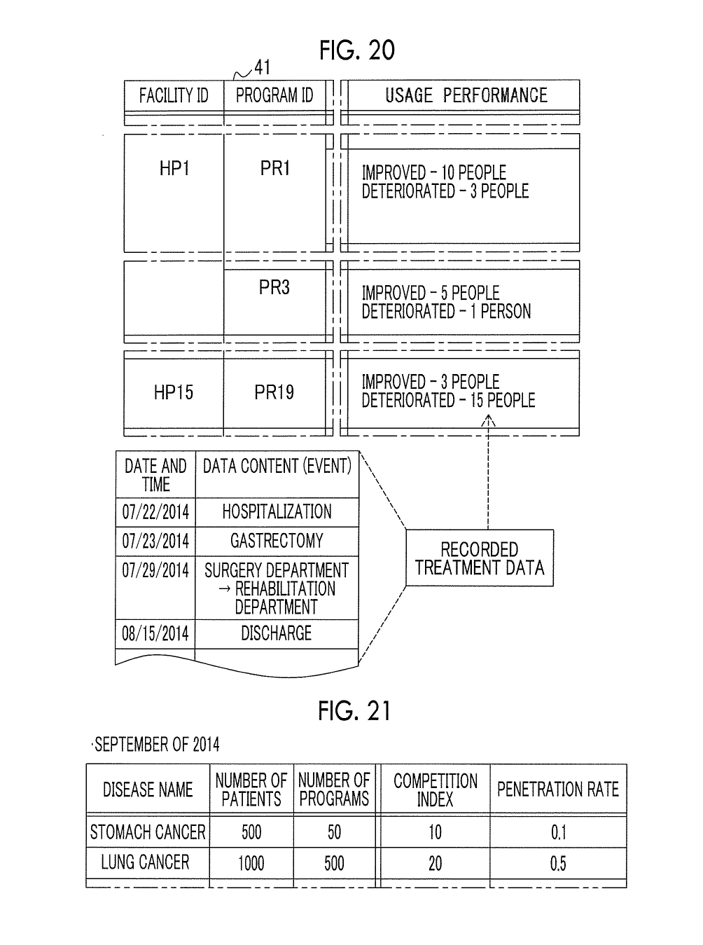

The electronic medical chart 24 stores recorded examination data which records inquiry content, diagnosis content, diseases, and the like as medical examination data; test data such as test values of medical tests including test substance testing such as blood tests and biochemical tests, and physiological tests such as electroencephalography; measurement data including measured values of vital signs such as a heart rate, a pulse, blood pressure, and a body temperature of a patient; recorded treatment data (refer to FIGS. 19 and 20) which records events occurring during a patient's medical examination, such as first visit, hospitalization, discharge, re-hospitalization, treatment, operation, medication, and complete recovery. The various data items of the electronic medical chart 24 can be input by the facility terminal 16, and the electronic medical chart 24 can be viewed by the facility terminal 16.

The test image 25 includes images obtained in various image tests such as computed tomography (CT) tests, magnetic resonance imaging (MRI) tests, simple X-ray tests, ultrasonic tests, and endoscopic tests, and is created, for example, in a digital imaging and communications in medicine (DICOM) format. The test image 25 can be viewed by the facility terminal 16.

The electronic medical chart 24 and the test image 25 are stored in correlation with patient identification data (ID) which is a number for identification of each patient as additional information. The electronic medical chart 24 and the test image 25 can be retrieved from the respective DBs 22 and 23 with the additional information such as the patient ID as a search key.

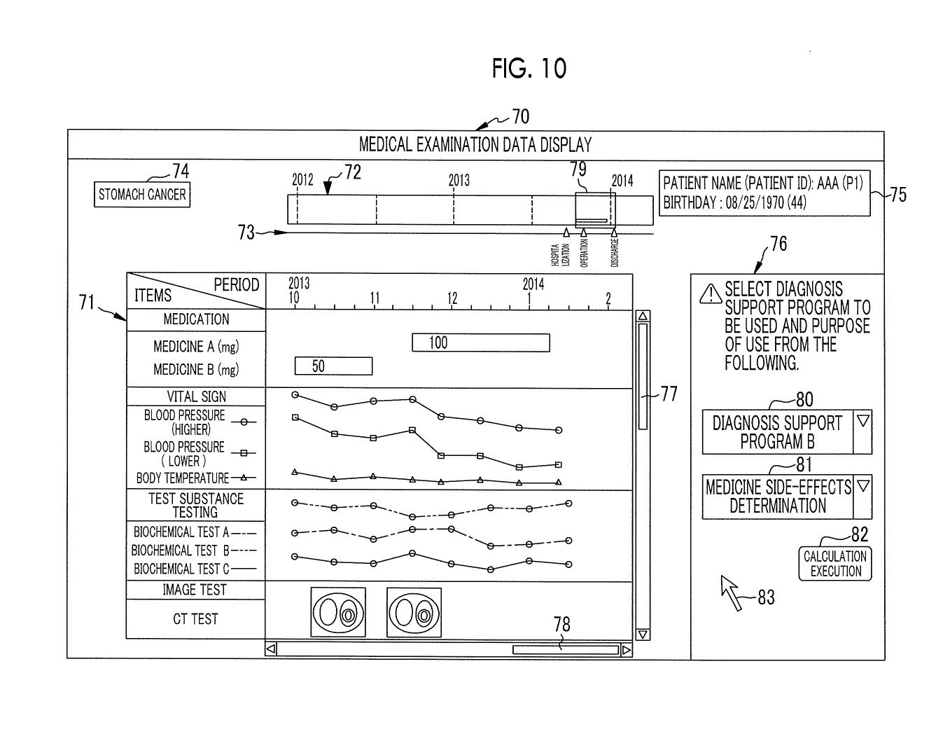

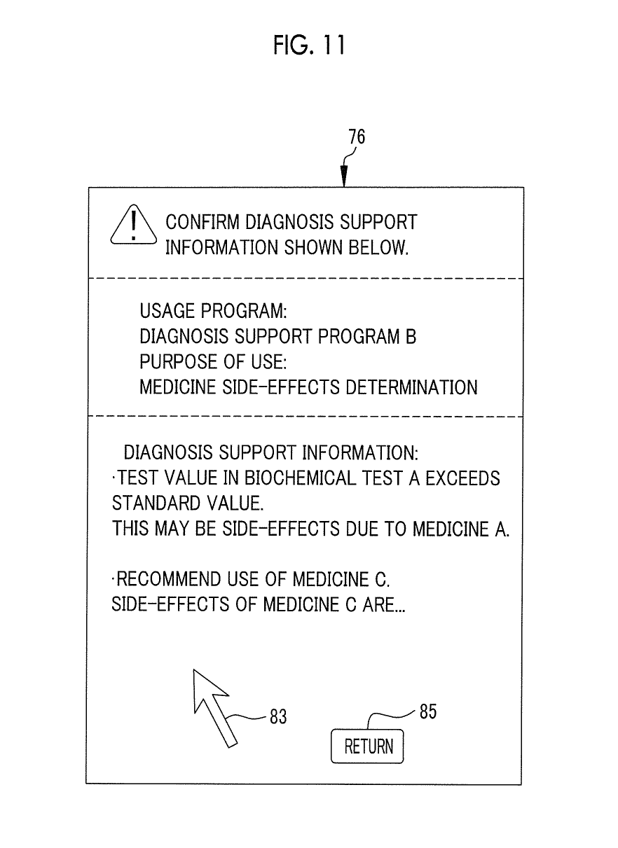

The diagnosis support program 30 performs calculation by using the various medical examination data items stored in the respective DBs 22 and 23 as input data, and outputs a calculation result as diagnosis support information for supporting diagnosis related to a patient. The diagnosis support information is displayed so as to be superimposed on a medical examination data display screen 70 (refer to FIG. 10) which displays the medical examination data (refer to FIG. 11).

In FIG. 2, the vendor terminal 17 uploads the developed diagnosis support program 30 to the center server 15. The center server 15 receives a plurality of diagnosis support programs 30 which are uploaded from the vendor terminal 17 of each vendor 12 and collectively stores and manages the programs. The center server 15 transmits the diagnosis support program 30 to the facility terminal 16 in response to a download request from the facility terminal 16.

The center server 15 receives facility information regarding the medical facility 11 and actual usage situation information regarding actual usage situations of the diagnosis support program 30 from the facility terminal 16. The facility terminal 16 transmits the actual usage situation information to the center server 15 for each of predetermined periods, for example, every month in the present embodiment. In other words, the facility terminal 16 corresponds to a transmission source of the actual usage situation information.

The center server 15 receives an information providing request for development reference information from the vendor terminal 17, and transmits the development reference information based on the facility information and the actual usage situation information to the vendor terminal 17 in response to the received information providing request.

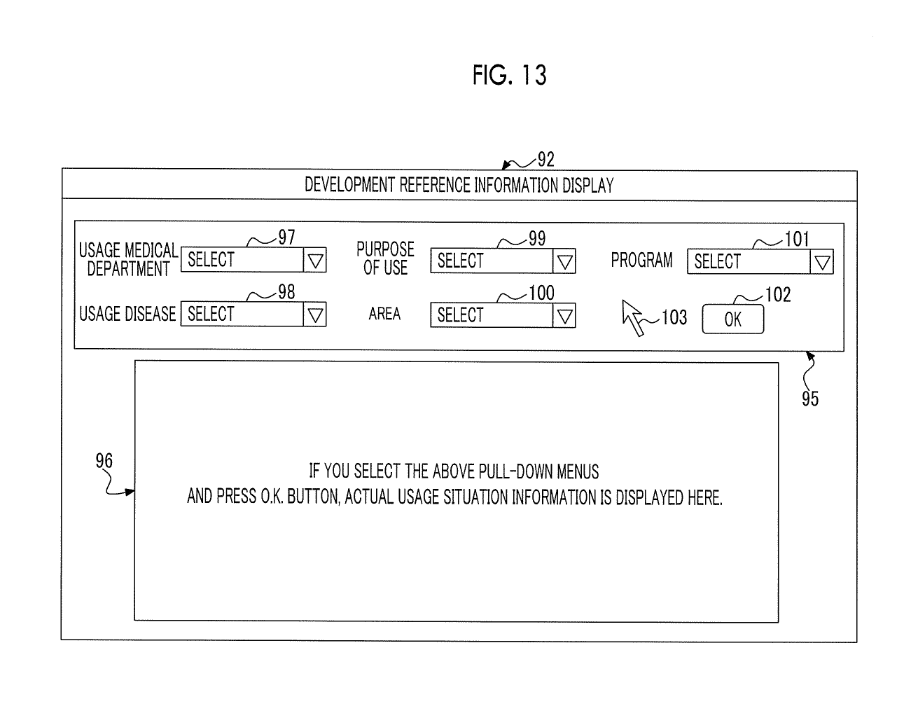

Specifically, as a form of providing the development reference information, the center server 15 generates a development reference information display screen 92 (refer to FIG. 13 or the like) and transmits the generated development reference information display screen 92 to the vendor terminal 17.

More specifically, the center server 15 opens an information publishing site which is used to publish the development reference information and can be viewed on a web browser, and issues an authentication key to a vendor 12 which has made a contract for the development reference information providing service so as to give access rights to the information publishing site to the vendor 12. The center server 15 delivers the development reference information display screen 92 in an XML data format for web delivery, which is created in a markup language such as extensible markup language (XML), to the vendor terminal 17. The vendor terminal 17 reproduces and displays the development reference information display screen 92 on the web browser on the basis of the XML data. In other words, the vendor terminal 17 also functions as a development reference information viewing terminal.

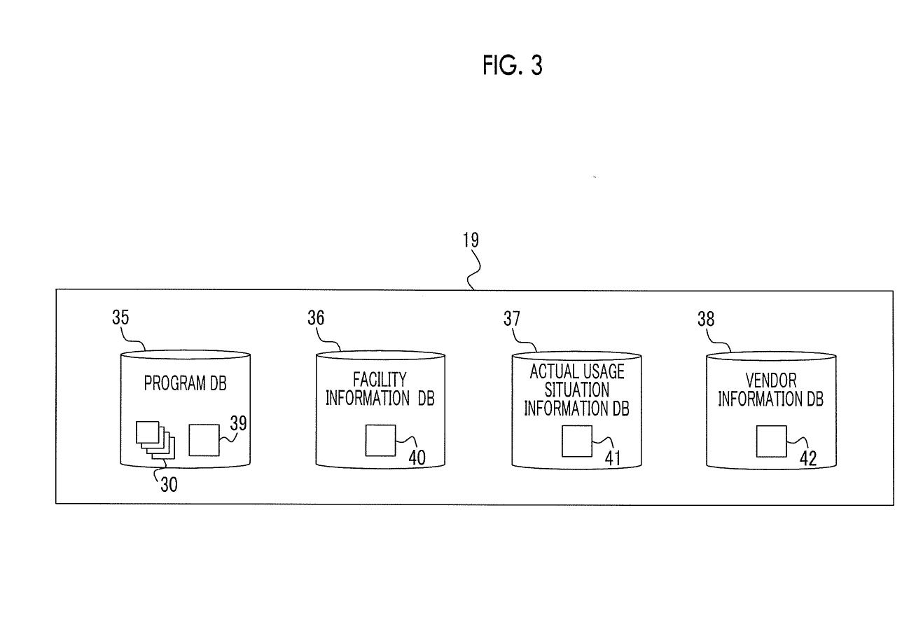

In FIG. 3, the DB group 19 connected to the center server 15 includes a program DB 35, a facility information DB 36, an actual usage situation information DB 37, and a vendor information DB 38. The program DB 35 stores the diagnosis support program 30 and a program list 39, and the facility information DB 36 stores a facility information list 40. The actual usage situation information DB 37 stores an actual usage situation information list 41, and the vendor information DB 38 stores a vendor information list 42.

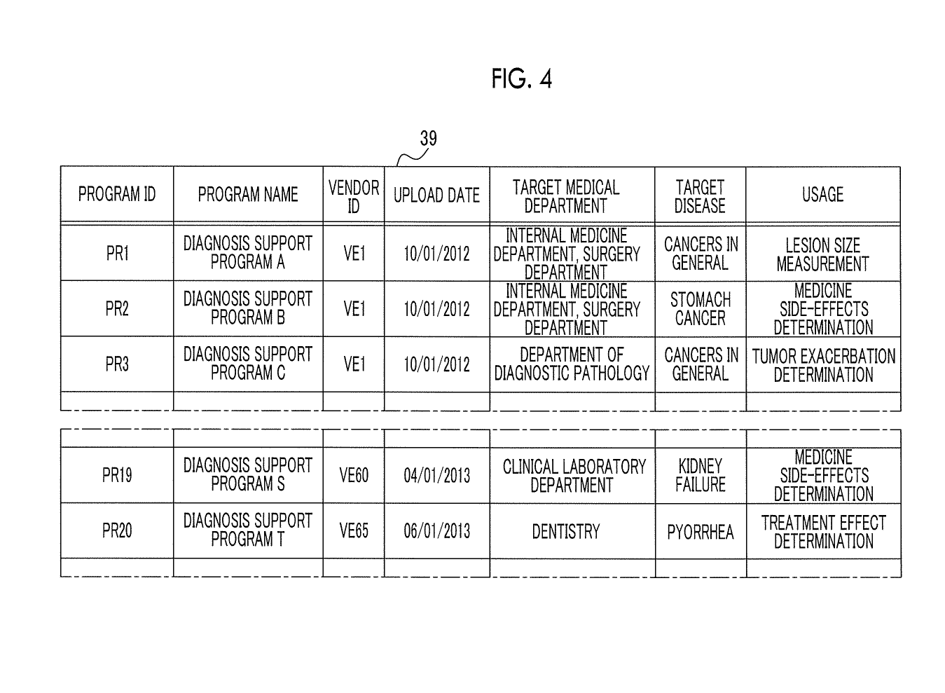

In FIG. 4, the program list 39 includes items such as program identification data (ID), a program name, a vendor ID, the upload date, a target medical department, a target disease, and a usage.

The program ID is an ID which is used to manage each diagnosis support program 30 in the center server 15, and is automatically added by the center server 15, for example, when the diagnosis support program 30 is uploaded from the vendor terminal 17. The program name is the name of the diagnosis support program 30 given by the vendor 12. The vendor ID is an ID which is used to manage each vendor 12 in the center server 15, and is automatically added by the center server 15 when a contract for a service is made. A vendor ID of the vendor 12 which has developed the corresponding diagnosis support program 30 is registered in the vendor ID item. The upload date is the date when the diagnosis support program 30 is uploaded to the center server 15.

The target medical department and the target disease are respectively a medical department and a disease for which the use of the diagnosis support program 30 is recommended by the vendor 12. In the target medical department item, for example, a plurality of medical departments such as “an internal medicine department and a surgery department” may be registered, and only a single medical department such as “department of diagnostic pathology” may be registered. In the target disease item, for example, a single disease such as “stomach cancer” may be registered, and the kind of disease which is not limited to a single disease, such as “cancers in general”, may be registered. Although not illustrated, for example, complex diseases such as “diabetes+kidney failure” may be registered in the target disease item.

The usage indicates a main usage of the diagnosis support program 30. In the usage item, for example, in a case of the diagnosis support program 30 for measuring a lesion size, “lesion size measurement” is registered, in a case of the diagnosis support program 30 for determining side-effects of a medicine, “medicine side-effects determination” is registered, and in a case of the diagnosis support program 30 for determining exacerbation of a tumor, “tumor exacerbation determination” is registered.

The respective items such as the target medical department, the target disease, and the usage are input by the vendor 12 via the vendor terminal 17 when the diagnosis support program 30 is uploaded. Registration in the target medical department, the target disease, and the usage is not essential, and the items may be vacant for the diagnosis support program 30 for which the items are not particularly defined. Not only a program ID added by the center server 15 but also an item such as a program ID added by the vendor 12 or version information of the diagnosis support program 30 may be added to the program list 39.

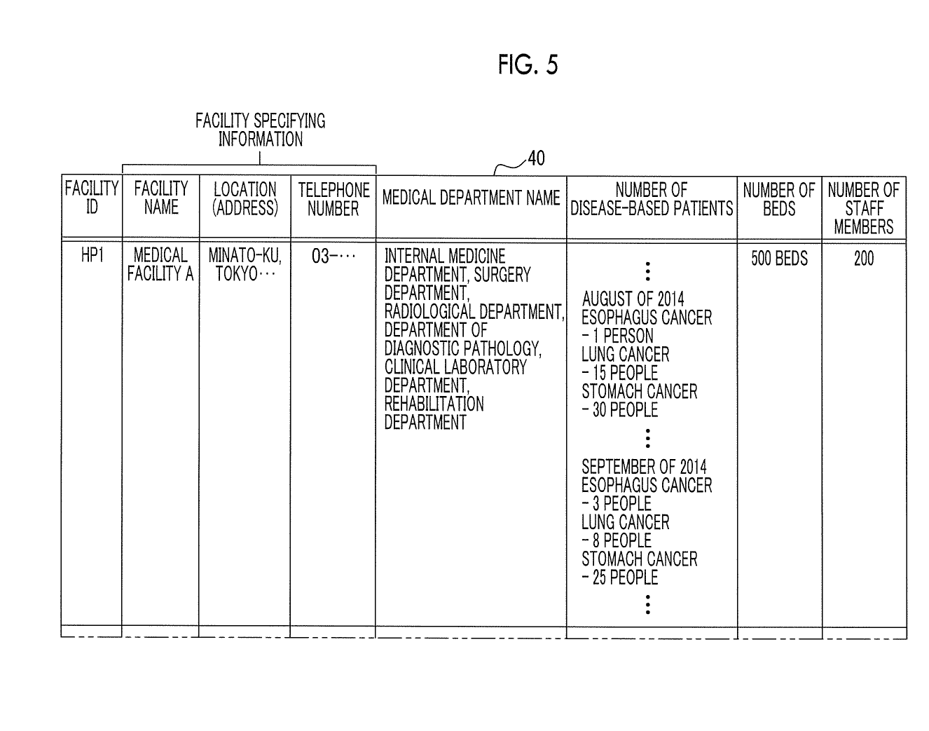

In FIG. 5, the facility information list 40 includes respective items such as a facility ID, a facility name, a location (address), a telephone number, a medical department name, the number of disease-based patients, the number of beds, and the number of staff members.

The facility ID is an ID which is used to manage each medical facility 11 in the center server 15 and is automatically added by the center server 15 when a contract for a service is made in the same manner as the vendor ID. The facility name is the name of the medical facility 11. An address of the medical facility 11 is registered in the location item, and a representative telephone number of the medical facility 11 is registered in the telephone number item. The facility name, the location, and the telephone number are facility specifying information which can specify the medical facility 11 and are thus concealment targets when the development reference information is provided to the vendor 12.

The names of respective medical departments present in the medical facility 11 are registered in the medical department name item. The names of diseases treated by the medical facility 11 for one month and the number of patients thereof are registered in the item of the number of disease-based patients.

The number of beds indicates the number of inpatients who can be accepted by the medical facility 11. The number of staff members indicates the number of staff members such as doctors, nurses, and pharmacists who engage in medical practices or practices equivalent thereto. The number of staff members who are in charge of accounting work or reception work and thus do not engage in medical practices or practices equivalent thereto may or may not be included in the number of staff members. The number of beds and the number of staff members are information indicating a size of the medical facility 11.

The respective items of the facility information excluding the number of disease-based patients are obtained, for example, by being reported by the medical facility 11 when the contract for the service is made. On the other hand, the number of disease-based patients is totalized in the medical facility 11 side for one month, and is transmitted from the facility terminal 16 to the center server 15 every month. For this reason, the number of disease-based patients for each month such as “August of 2014” or “September of 2014” is stored in the item of the number of disease-based patients. Instead of or in addition to the number of disease-based patients for each month, the number of disease-based patients which are obtained by counting all patients treated hitherto by the medical facility 11 depending on diseases may be registered. Only the names of diseases which are treated for one month or hitherto may be registered.

In addition, doctor information such as an ID or a name of a doctor of the medical facility 11, a medical department to which the doctor belongs, and his/her major, an exterior picture of the medical facility 11, an affiliated medical association of the medical facility 11, equipment owned by the medical facility 11, or a uniform resource locator (URL) of a website which is opened by the medical facility 11 may be added to the items of the facility information list 40. In a case where the items of the name of the doctor, the exterior picture of the medical facility 11, the URL of the site opened by the medical facility 11 are added, the items specify the medical facility 11 and are thus concealment targets along with the above-described facility name and the like.

The respective items of the facility information excluding the number of disease-based patients are updated at any time in a case where the items change. The respective items of the facility information excluding the number of disease-based patients may be collectively updated, for example, when a contract with the center server 15 is updated.

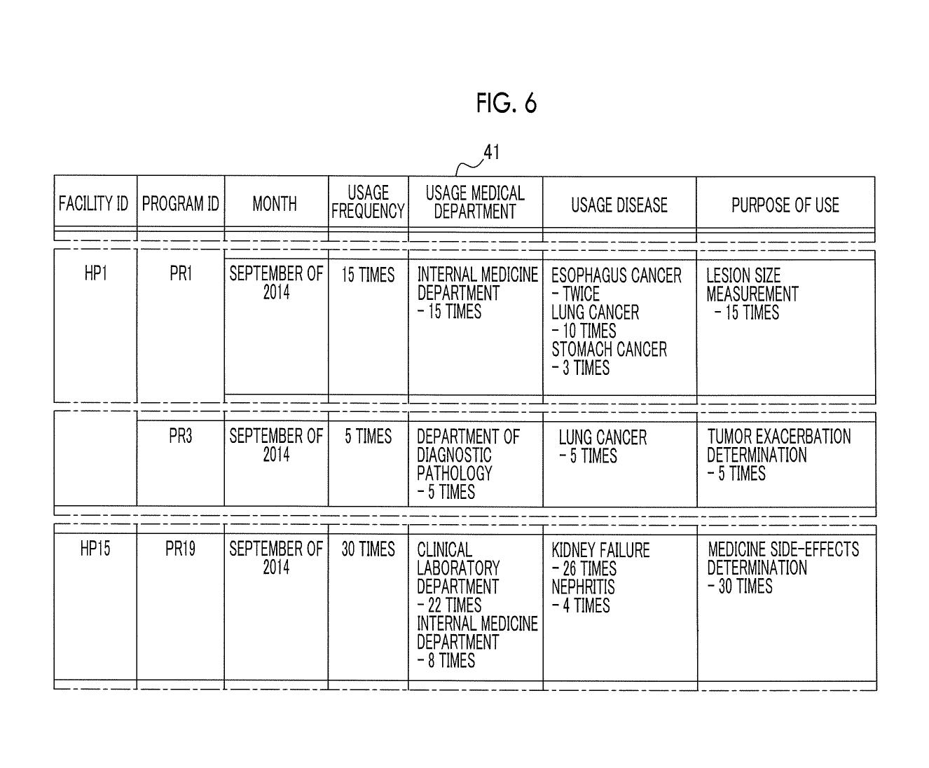

In FIG. 6, the actual usage situation information list 41 includes respective items such as a facility ID, a predetermined ID, a month, a usage frequency, a usage medical department, a usage disease, and a purpose of use. The respective items such as the usage frequency, the usage medical department, the usage disease, and the purpose of use are separated for each facility ID, each predetermined ID, and each month.

A month on which the respective items such as the usage frequency, the usage medical department, the usage disease, and the purpose of use are acquired is registered in the month item. The number of times of using the diagnosis support program 30 indicated by the program ID in the facility terminal 16 of the medical facility 11 indicated by the facility ID for one month is registered in the usage frequency item. The usage medical department, the usage disease, and the purpose of use form pairs with the target medical department, the target disease, and the usage of the program list 39, and a medical department and a disease in which the diagnosis support program 30 is actually used, a purpose of use and a usage frequency thereof are registered in the items.

The respective items such as the usage frequency, the usage medical department, the usage disease, and the purpose of use are totalized in the medical facility 11 side for each month, and are transmitted from the facility terminal 16 to the center server 15 every month in the same manner as the number of disease-based patients of the facility information. Thus, the respective items such as the usage frequency, the usage medical department, the usage disease, and the purpose of use are stored every month.

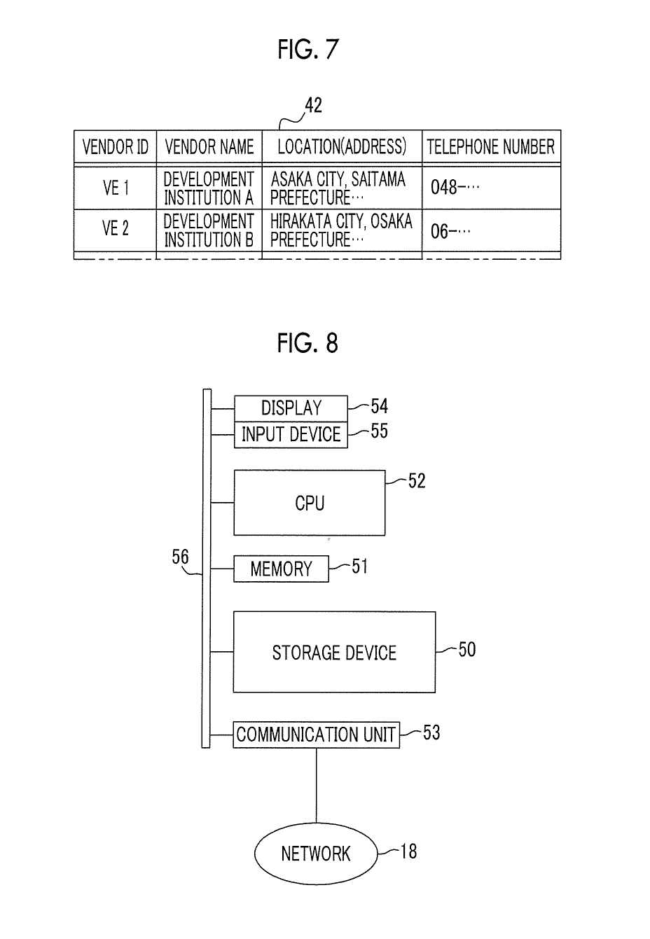

In FIG. 7, the vendor information list 42 includes respective items such as a vendor ID, a vendor name, a location (address), and a telephone number. In the same manner as in the case of the facility information list 40, a name, an address, and a representative telephone number of the vendor 12 are registered in the respective items such as the vendor name, the location, the telephone number. In addition, in the same manner as in the facility information list 40, developer information such as an ID or a name of a developer belonging to the vendor 12, or a URL of a website opened by the vendor 12 may be added to the items of the vendor information list 42.

The center server 15, the facility terminal 16, and the vendor terminal 17 are configured by installing a control program such as an operating system, or an application program such as a server program or a client program, with computers such as a server computer, a personal computer, and a workstation as bases.

In FIG. 8, computers constituting the center server 15 and the like have the same fundamental configuration, and each of the computers includes a storage device 50, a memory 51, a central processing unit (CPU) 52, a communication unit 53, a display 54, and an input device 55.

The above-described elements are connected to each other via a data bus 56.

The storage device 50 is a hard disk drive which is built into the computer constituting each of the center server 15 and the like or which is connected via a cable or a network, or a disk array in which a plurality of hard disk drives are continuously disposed. The storage device 50 stores a control program such as an operating system, various application programs, and display data regarding various operation screens associated with the programs.

The memory 51 is a work memory for the CPU 52 performing processes. The CPU 52 loads the program stored in the storage device 50 to the memory 51, and comprehensively controls each unit of the computer by performing processes according to the program.

The communication unit 53 is a network interface which controls transmission of various information pieces via the network 18. The display 54 displays various operation screens corresponding to operations of the input device 55 such as a mouse or a keyboard. An operation function based on a graphical user interface (GUI) is provided on the operation screen. The computer constituting each of the center server 15 and the like receives inputting of an operation instruction from the input device 55 via the operation screen.

In the following description, the subscript “A” is added to each unit of the computer constituting the center server 15, the subscript “B” is added to each unit of the computer constituting the facility terminal 16, and the subscript “C” is added to each unit of the computer constituting the vendor terminal 17.

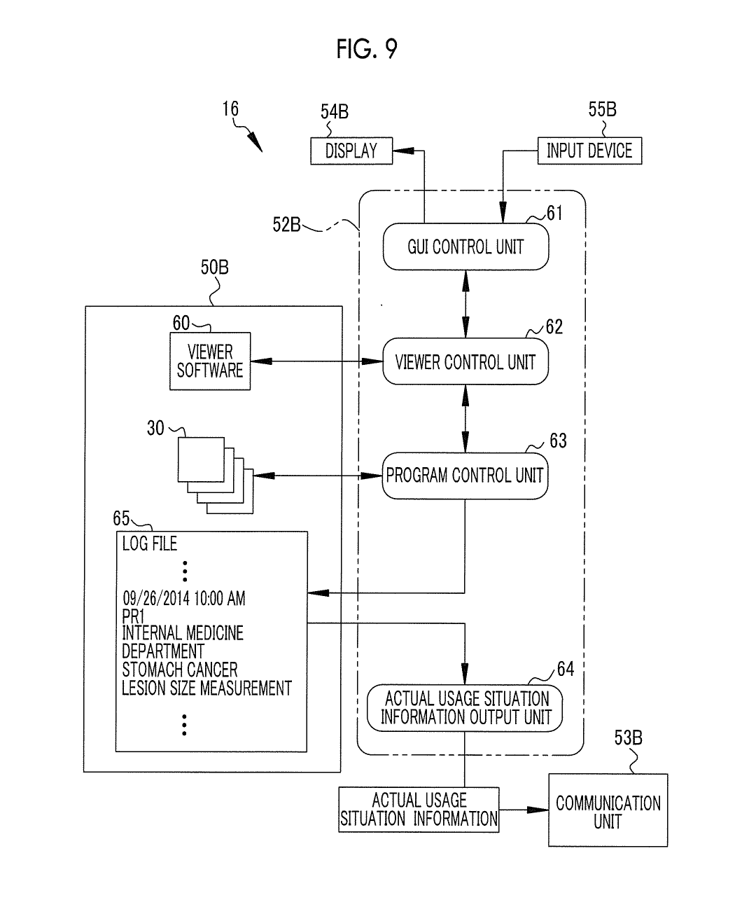

In FIG. 9, the storage device 50B of the facility terminal 16 stores viewer software 60, the diagnosis support program 30, or the like which is downloaded from the center server 15. The viewer software 60 is provided from the center server 15 when a contract for a service is made. The viewer software 60 is software for displaying diagnosis support information on a medical examination data display screen 70 by operating a plurality of diagnosis support programs 30, along with display of medical examination data.

If the viewer software 60 is activated, the CPU 52B of the facility terminal 16 functions as a GUI control unit 61, a viewer control unit 62, a program control unit 63, and an actual usage situation information output unit 64 in cooperation with the memory 51B (not illustrated).

The GUI control unit 61 realizes a screen display control function of displaying the medical examination data display screen 70 on the display 54B. The GUI control unit 61 receives an operation instruction which is input from the input device 55B via the medical examination data display screen 70 and delivers the operation instruction to the viewer control unit 62.

The viewer control unit 62 controls an operation of the viewer software 60. The viewer control unit 62 generates an activation screen, and receives inputting of a patient ID via the activation screen. The viewer control unit 62 transmits a delivery request for medical examination data to the electronic medical chart server 20 and the image server 21 with the patient ID received via the activation screen as a search key. The viewer control unit 62 receives the medical examination data transmitted from the electronic medical chart server 20 and the image server 21 in response to the delivery request, generates the medical examination data display screen 70 on the basis thereof, and outputs the generated medical examination data display screen 70 to the GUI control unit 61.

The viewer control unit 62 receives an instruction for selecting the diagnosis support program 30 to be used, and a calculation execution instruction for causing the diagnosis support program 30 to perform calculation, via the medical examination data display screen 70. The viewer control unit 62 delivers the medical examination data to the program control unit 63 as input data of the diagnosis support program 30.

The program control unit 63 controls an operation of the diagnosis support program 30. In other words, the diagnosis support program 30 is executed under the control of the program control unit 63. In a case where the viewer control unit 62 receives the calculation execution instruction, the program control unit 63 activates the diagnosis support program 30 corresponding to the selection instruction received by the viewer control unit 62, and causes the diagnosis support program 30 to perform calculation by using the medical examination data delivered from the viewer control unit 62 as input data and thus causes the diagnosis support program 30 to output diagnosis support information.

The program control unit 63 delivers the diagnosis support information to the viewer control unit 62. The viewer control unit 62 displays the diagnosis support information so as to be superimposed on the medical examination data display screen 70.

The program control unit 63 records a log file 65 indicating calculation execution history of the diagnosis support program 30 in the storage device 50B whenever the diagnosis support program 30 performs calculation. The log file 65 includes data required in the actual usage situation information, such as not only the date and time at which calculation is performed in the diagnosis support program 30 but also a program ID, a usage medical department, a usage disease, and a purpose of use of the diagnosis support program 30 performing the calculation. The usage medical department is acquired by a doctor inputting the medical department, for example, on an initial screen displayed when the viewer software 60 is initially started.

The actual usage situation information output unit 64 generates actual usage situation information of the diagnosis support program 30 corresponding to one month by referring to the log file 65 corresponding to one month, for example, every month. The actual usage situation information output unit 64 outputs the generated actual usage situation information to the communication unit 53B. The outputting of the actual usage situation information in the actual usage situation information output unit 64 is automatically performed every month according to a specification of the viewer software 60.

The actual usage situation information output unit 64 counts treated patients for one month depending on diseases so as to calculate the number of disease-based patients on the basis of a description or the like of recorded examination data of the electronic medical chart 24. The calculated number of disease-based patients is output to the communication unit 53B along with the actual usage situation information.

In FIG. 10, the medical examination data display screen 70 includes a medical examination data display region 71, a period display region 72, an event display region 73, a disease display region 74, a patient information display region 75, and a various-information-pieces display region 76.

In the medical examination data display region 71, names of rough classification of respective items of medical examination data such as “medication”, “vital sign”, “test substance testing”, and “image tests”, and names of respective items of medical examination data such as “medicines A and B”, “blood pressure (higher), blood pressure (lower), and body temperature”, “biochemical tests A, B and C”, and “CT tests” are displayed in a vertical axis direction, and a period (hereinafter, referred to as a first period) in which medical examination data displayed in the medical examination data display region 71 is acquired among medical examination data items in the entire medical examination process of a patient is displayed in a horizontal axis direction. In FIG. 10, the first period is about three and a half months from October of 2013 to the middle of January of 2014.

A bar indicating the start date and end date of medication and a dose in the first period, a line graph obtained by plotting measured values of the vital sign or test values in the test substance testing in the first period and connecting the values to each other with a line, a thumbnail image of the test image 25 obtained in the first period, and the like are displayed in the medical examination data display region 71. The plots of the measured values or the test values forming the bar or the line graph, and the thumbnail image are disposed at positions corresponding to the medication date and time, the measurement date and time, and the test date and time. The medical examination data display region 71 can be scrolled vertically and horizontally by using scroll bars 77 and 78.

The period display region 72 is a region in which a period (hereinafter, referred to as a second period) whose time scale is longer than that of the first period displayed in the medical examination data display region 71 is displayed. A period indicator 79 is provided in the period display region 72. The period indicator 79 indicates the corresponding first period in the second period. A width of the period indicator 79 corresponds to a width of the first period in the time scale of the second period. In FIG. 10, since the first period is about three and a half months, the width of the period indicator 79 corresponds to the width of about three and a half months in the time scale of the second period.

The period indicator 79 is moved in the horizontal direction of the period display region 72 in conjunction with an operation of the scroll bar 78. A display range of the first period may be changed by moving the period indicator 79 in the horizontal direction or changing the width of the period indicator 79. The first period which is initially displayed may be a predetermined period before acquisition of the latest medical examination data, and may be designated by a doctor when a patient ID is input on the activation screen.

The event display region 73 displays the date and time on which an event occurs during medical examination of a patient, such as the hospitalization date, the discharge date, and the operation date. The disease display region 74 displays a disease name of a patient with a patient ID which is input on the activation screen. The disease displayed in the disease display region 74 is recorded in the log file 65 by the program control unit 63 as a usage disease. The disease displayed on the disease display region 74 may be extracted from the description of the recorded examination data of the electronic medical chart 24, and may be input by a doctor when a patient ID is input on the activation screen. The patient information display region 75 displays basic information such as the name of a patient with a patient ID, the patient ID, and the date of the patient's birth which are input on the activation screen.

The various-information-pieces display region 76 displays a message for prompting the diagnosis support program 30 which is used and a purpose of use thereof to be selected, a pull-down menu 80 for selecting the diagnosis support program 30, a pull-down menu 81 for selecting a user purpose, and a calculation execution button 82. The pull-down menu 80 gives a selection instruction to the viewer control unit 62, and the calculation execution button 82 gives a calculation execution instruction to the viewer control unit 62.

The pull-down menu 80 displays names of the diagnosis support programs 30 which match a purpose of use selected in the pull-down menu 81 and the usage of the program list 39 as options among the diagnosis support programs 30 stored in the storage device 50B. In other words, the pull-down menu 81 is used to narrow down the diagnosis support programs 30 displayed in the pull-down menu 80 as options, depending on the usage. A program ID of the diagnosis support program 30 selected in the pull-down menu 80, and the purpose of use selected in the pull-down menu 81 are recorded in the log file 65 by the program control unit 63. In FIG. 10, a “diagnosis support program B” is selected in the pull-down menu 80, and “medicine side-effects determination” is determined in the pull-down menu 81.

If the desired diagnosis support program 30 and purpose of use are selected in the pull-down menus 80 and 81, and the calculation execution button 82 is clicked with a cursor 83, the program ID of the diagnosis support program 30 selected in the pull-down menu 80 and the purpose of use selected in the pull-down menu 81 are delivered to the program control unit 63 via the GUI control unit 61 and the viewer control unit 62. In addition, calculation is performed by the diagnosis support program 30 under the control of the program control unit 63. Regarding medical examination data delivered to the program control unit 63 as input data from the viewer control unit 62, medical examination data may be set in advance for each diagnosis support program 30, and medical examination data designated on the medical examination data display screen 70 by a doctor may be used as input data.

When the diagnosis support information is output from the diagnosis support program 30, display of the various-information-pieces display region 76 changes as illustrated in FIG. 11. The various-information-pieces display region 76 displays a message for prompting the diagnosis support information to be checked, the name of the used diagnosis support program 30 and the purpose of use, the diagnosis support information, and a return button 85 for returning to the state illustrated in FIG. 10. FIG. 11 exemplifies the “diagnosis support program B” as the used diagnosis support program 30, the “medicine side-effects determination” as the purpose of use, the opinion on an test value in the “biochemical test A”, a comment for recommending the use of a “medicine C” other than the “medicines A and B”, and a comment regarding side-effects of the “medicine C”.

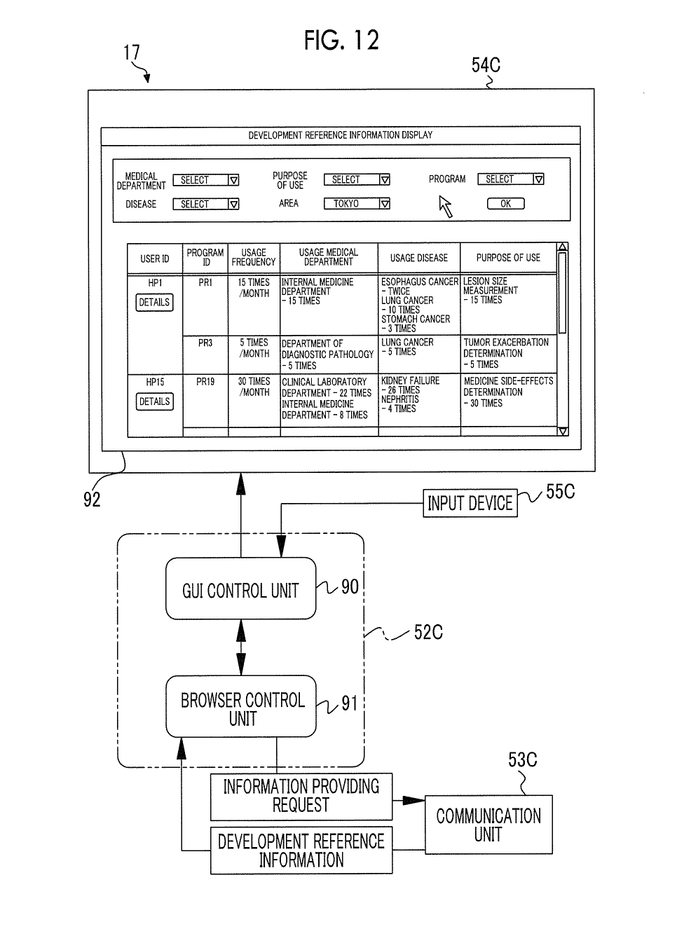

In FIG. 12, if a web browser is activated as an application program, the CPU 52C of the vendor terminal 17 functions as a GUI control unit 90 and a browser control unit 91 in cooperation with the memory 51C (not illustrated). The center server 15 is accessed through an operation using the input device 55C under the control of the GUI control unit 90 and the browser control unit 91, and authentication for the information publishing site is performed.

The GUI control unit 90 realizes a screen display control function of displaying a development reference information display screen 92 on the display 54C. The GUI control unit 90 receives an operation instruction which is input from the input device 55C via the development reference information display screen 92 and delivers the operation instruction to the browser control unit 91.

The browser control unit 91 controls an operation of the web browser. The browser control unit 91 issues an information providing request to the center server 15 to the communication unit 53C in response to the operation instruction from the input device 55C via the GUI control unit 90. The browser control unit 91 receives the development reference information which is transmitted from the center server 15 and is received by the communication unit 53C, that is, XML data of the development reference information display screen 92. The browser control unit 91 reproduces the development reference information display screen 92 which is displayed on the web browser on the basis of the XML data and outputs the screen to the GUI control unit 90.

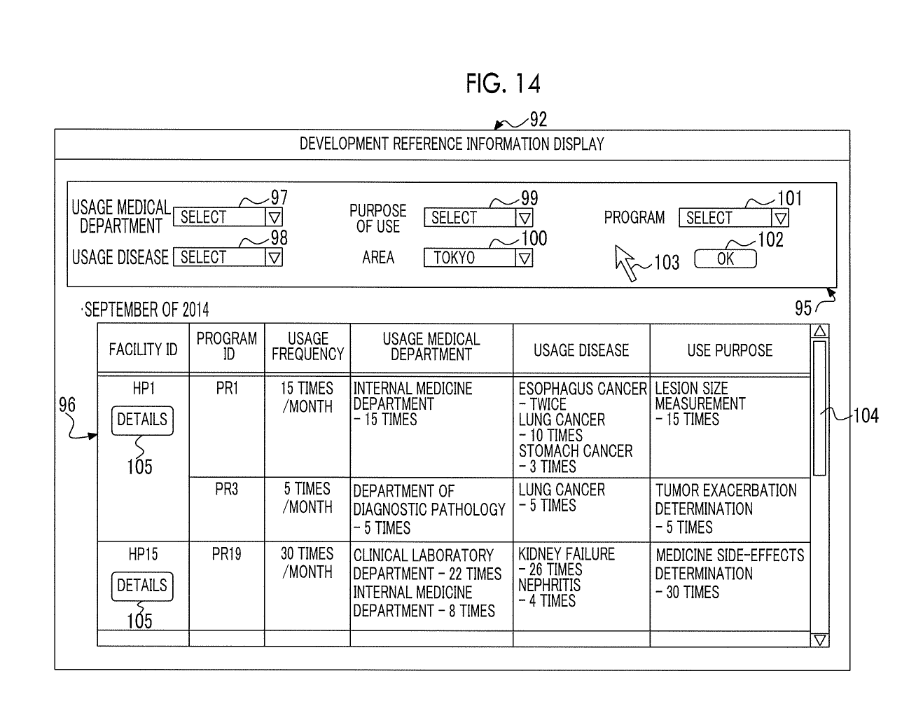

In FIGS. 13 and 14, the development reference information display screen 92 includes a search key selection region 95 and an actual usage situation information display region 96.

The search key selection region 95 is provided with pull-down menus 97, 98, 99, 100 and 101 for selecting a usage medical department, a usage disease, a purpose of use, an area, and the diagnosis support program 30, and an O.K. button 102. A medical department name, a disease name, and a purpose of use are respectively displayed as options in the pull-down menus 97, 98 and 99. The pull-down menu 100 displays, for example, a medical area (the second medical area in the units of a plurality of cities, towns, and villages, or the third medical area in the units of prefectures) defined according to a medical law, or an area name of the countryside such as Tohoku or Kanto, as options. The pull-down menu 101 displays all diagnosis support programs 30 registered in the program list 39, or names of the diagnosis support programs 30 which are uploaded in the vendor terminal 17 by the vendor 12 which is viewing the development reference information display screen 92 among all the diagnosis support programs 30 registered in the program list 39, as options.

At least one of the pull-down menus 97 to 101 may be selected. Although not illustrated for avoiding complexity, a plurality of pull-down menus 97 to 101 may be added, and, for example, as a usage medical department, an “internal medicine department” and a “surgery department” can be selected. A search operator such as AND, OR, or NOT may be designated, and a so-called AND search, OR search, or NOT search may be made in each option of the pull-down menus 97 to 101. In addition to the pull-down menus 97 to 101, a pull-down menu for designating a month, an input box for designating a period such as “January to September of 2014”, and an input box for designating the number of beds or a range of the number of staff members, such as “500 to 1000 as the number of beds” or “100 to 200 as the number of staff members” may be provided.

FIG. 13 illustrates an initial screen of the development reference information display screen 92 which is initially displayed on the web browser after the authentication is performed in the information publishing site. On the initial screen, the actual usage situation information is not displayed in the actual usage situation information display region 96, and a message for prompting the pull-down menus 97 to 101 to be selected is displayed.

If desired options are selected in the pull-down menus 97 to 101, and the O.K. button 102 is clicked with a cursor 103, an information providing request with the options selected in the pull-down menus 97 to 101 as search keys is issued from the browser control unit 91 to the communication unit 53C.

FIG. 14 illustrates an example of the development reference information display screen 92 which is transmitted from the center server 15 in a case where “Tokyo” is selected in the pull-down menu 100 (the pull-down menus 97 to 99 and 101 are not selected), and the O.K. button 102 is clicked. In this case, actual usage situation information in the latest month (in this example, “September of 2014”) for the medical facilities 11 located in Tokyo is displayed in a list form in the actual usage situation information display region 96. The actual usage situation information display region 96 can be scrolled in the vertical direction by using a scroll bar 104. A sorting function of sorting the actual usage situation information in an order of increasing usage frequency may be installed in the actual usage situation information display region 96.

The actual usage situation information displayed in the actual usage situation information display region 96 of FIG. 14 is a result of performing a sorting process of sorting the entire actual usage situation information of the actual usage situation information list 41 according to an area such as “Tokyo”, and corresponds to statistical information obtained by sorting the actual usage situation information depending on diseases.

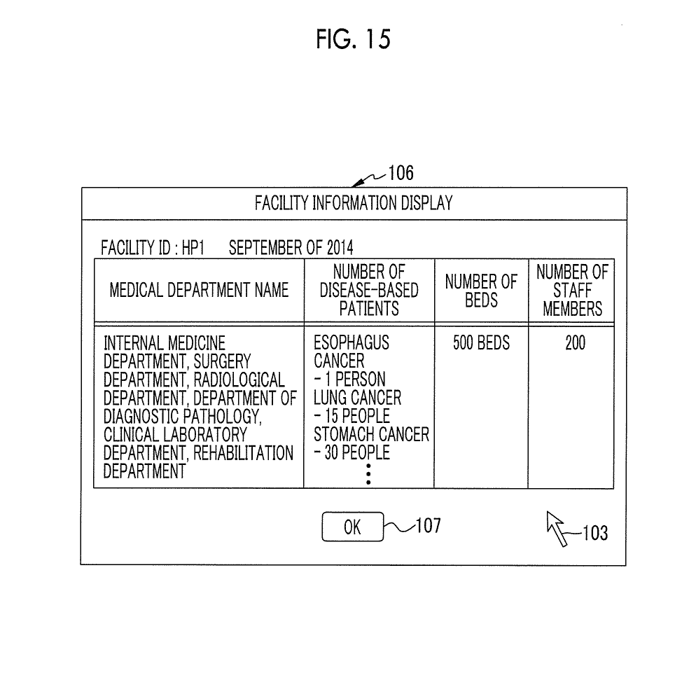

Each column of a facility ID of the actual usage situation information display region 96 is provided with a details button 105 for viewing facility information of the medical facility 11 with the facility ID. If the details button 105 is clicked with the cursor 103, a facility information display screen 106 illustrated in FIG. 15 is displayed on the development reference information display screen 92 in a pop-up form. Among the facility ID, the month, and the respective items of the facility information list 40, items excluding the facility specifying information such as the facility name, the location, and the telephone number, and, specifically, the medical department name, the number of disease-based patients, the number of beds, and the number of staff members are displayed on the facility information display screen 106. The number of disease-based patients in the same month as in the actual usage situation information displayed on the actual usage situation information display region 96 is displayed in the item of the number of disease-based patients. An O.K. button 107 is a button for removing the pop-up display of the facility information display screen 106.

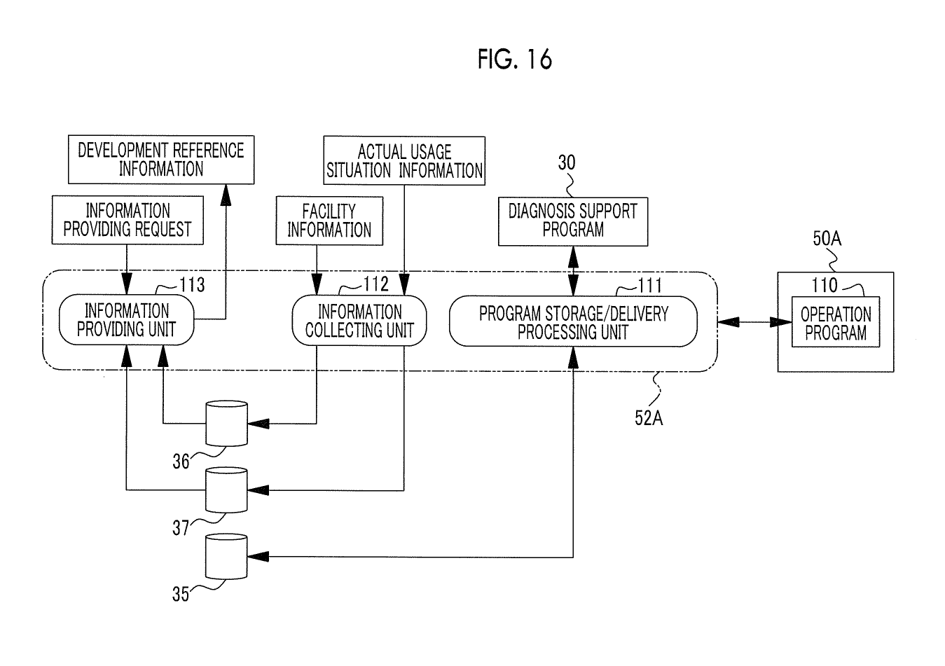

In FIG. 16, an operation program 110 is stored in the storage device 50A of the center server 15 as an application program. The operation program 110 is a program which causes the computer constituting the center server 15 to function as a diagnosis support program development promoting apparatus and a diagnosis support program development promoting server.

If the operation program 110 is activated, the CPU 52A of the center server 15 functions as a program storage/delivery processing unit 111, an information collecting unit 112, and an information providing unit 113 in cooperation with the memory 51A (not illustrated).

The program storage/delivery processing unit 111 stores the diagnosis support program 30 which is uploaded from the vendor terminal 17 in the program DB 35. In a case where the diagnosis support program 30 is stored, the program storage/delivery processing unit 111 newly creates a column for the stored diagnosis support program 30 in the program list 39, and fills in each item of the program list 39 so as to update the program list 39. The program storage/delivery processing unit 111 reads the diagnosis support program 30 from the program DB 35 in response to a download request from the facility terminal 16, and delivers the read diagnosis support program 30 to the facility terminal 16.

The information collecting unit 112 realizes an information collecting function of collecting actual usage situation information and facility information from the facility terminal 16 of each medical facility 11. In the present embodiment, the actual usage situation information is automatically transmitted from each facility terminal 16 every month, and thus the information collecting unit 112 only acquires, every other month, the actual usage situation information which is automatically transmitted. This is the same for the number of disease-based patients of the facility information. The respective items of the facility information excluding the number of disease-based patients are reported from the medical facility 11 when a contract for a service is made, so as to be collected in advance. The information collecting unit 112 registers the facility information in the facility information list 40 of the facility information DB 36 and registers the actual usage situation information in the actual usage situation information list 41 of the actual usage situation information DB 37, so as to update the lists 40 and 41.

The information providing unit 113 realizes an information providing function of providing development reference information in response to an information providing request from the vendor terminal 17, constituted of the search key selection region 95 of the development reference information display screen 92.

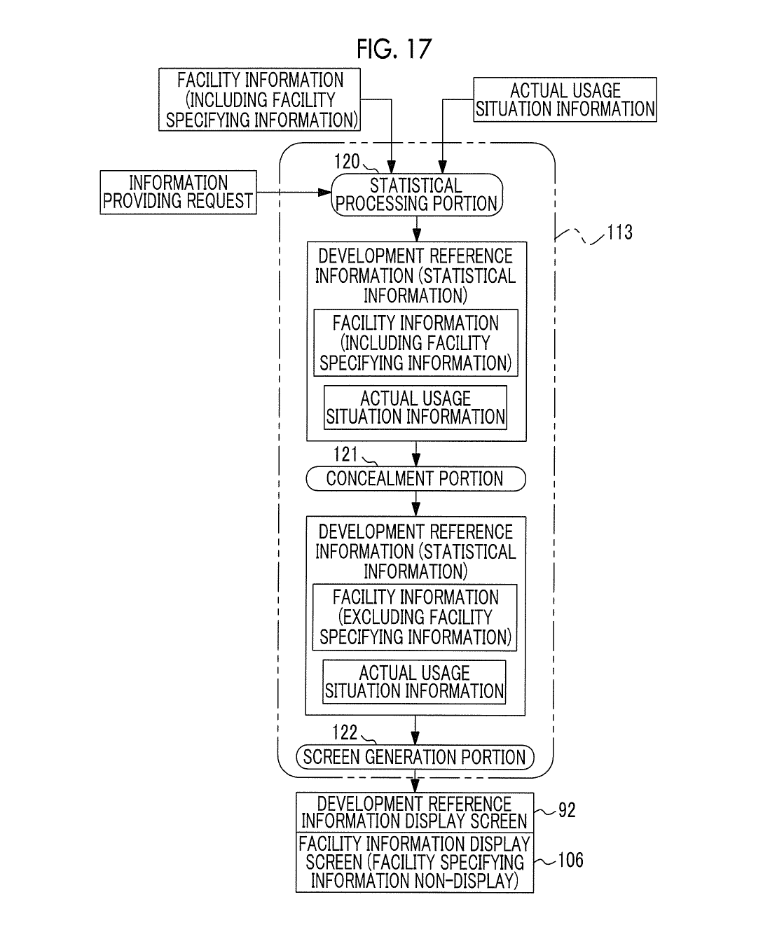

More specifically, as illustrated in FIG. 17, the information providing unit 113 includes a statistical processing portion 120, a concealment portion 121, and a screen generation portion 122. The statistical processing portion 120 realizes a statistical processing function of outputting statistical information as development reference information by performing a statistical process on the actual usage situation information and the facility information. Specifically, the statistical processing portion 120 uses options selected in the search key selection region 95 of the development reference information display screen 92 as search keys, picks up facility information corresponding to the search key from the facility information list 40 of the facility information DB 36 and picks up actual usage situation information corresponding to the search key from the actual usage situation information list 41 of the actual usage situation information DB 37, and delivers the picked-up facility information and actual usage situation information to the concealment portion 121 as development reference information.

For example, in a case where “lung cancer” is selected in the pull-down menu 98 of the usage disease, the statistical processing portion 120 picks up actual usage situation information (in the example illustrated in FIG. 6, actual usage situation information of the program IDs “PR1” and “PR3” of the facility ID “HP1”) in which “lung cancer” is registered in the usage disease item, from the actual usage situation information list 41. Further, facility information (in this example, facility information of the facility ID “HP1”) corresponding to the facility ID in the picked-up actual usage situation information is picked up from the facility information list 40.

For example, in a case where “Tokyo” is selected in the same manner as in FIG. 14 in the pull-down menu 100 of an area, facility information (in this example, facility information of the facility ID “HP1”) of the medical facility 11 in which “Tokyo” is registered in the location item is picked up from the facility information list 40, and actual usage situation information (in this example, actual usage situation information of the facility ID “HP1”) corresponding to the facility ID in the picked-up facility information is picked up from the actual usage situation information list 41.

The concealment portion 121 realizes a concealment function of concealing facility specifying information of the facility information delivered from the statistical processing portion 120. Specifically, the concealment portion 121 deletes the facility specifying information from the facility information. The concealment portion 121 delivers development reference information constituted of the facility information from which the facility specifying information is deleted and the actual usage situation information to the screen generation portion 122.

The screen generation portion 122 realizes a screen generation function of generating the development reference information display screen 92 and the facility information display screen 106. The screen generation portion 122 generates the development reference information display screen 92 and the facility information display screen 106 on the basis of the development reference information, delivered from the concealment portion 121, and constituted of the facility information from which the facility specifying information is deleted and the actual usage situation information. The screen generation portion 122 outputs the generated screens 92 and 106 to the communication unit 53A (not illustrated).

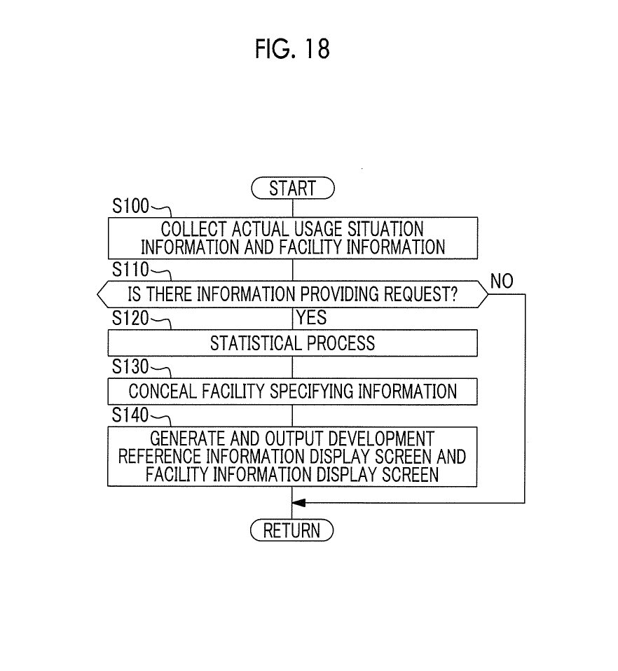

Hereinafter, an operation of the above-described configuration will be described with reference to a flowchart of FIG. 18. First, the operation program 110 is activated in the center server 15. Thus, the program storage/delivery processing unit 111, the information collecting unit 112, and the information providing unit 113 are built into the CPU 52A, and the computer constituting the center server 15 functions as a diagnosis support program development promoting apparatus and a diagnosis support program development promoting server.

In a case where the diagnosis support program 30 is uploaded from the vendor terminal 17, the program storage/delivery processing unit 111 stores the uploaded diagnosis support program 30 in the program DB 35. In a case where there is a download request for the diagnosis support program 30 from the facility terminal 16, the diagnosis support program 30 corresponding to the download request is read from the program DB 35 by the program storage/delivery processing unit 111 and is delivered to the facility terminal 16.

If the medical examination data display screen 70 is displayed on the display 54B in the facility terminal 16, and the diagnosis support program 30 is used via the medical examination data display screen 70, the log file 65 is recorded in the storage device 50B by the program control unit 63. In addition, actual usage situation information is generated by the actual usage situation information output unit 64 on the basis of the log file 65 corresponding to one month, and the actual usage situation information is output every month.

In step S100 of FIG. 18, the information collecting unit 112 collects the facility information and the actual usage situation information from the facility terminal 16. The collected facility information and actual usage situation information are respectively registered in the facility information list 40 of the facility information DB 36 and the actual usage situation information list 41 of the actual usage situation information DB 37 by the information collecting unit 112.

The vendor 12 accesses the information publishing site of the data center 10 via the vendor terminal 17 and performs authentication. After the authentication is performed, an initial screen of the development reference information display screen 92 is transmitted from the center server 15 to the vendor terminal 17 and is displayed on the display 54C of the vendor terminal 17.

In order to understand the needs of the medical facility 11 for the diagnosis support program 30, the vendor 12 selects desired options in the respective pull-down menus 97 to 101 of the search key selection region 95 of the development reference information display screen 92 and clicks the O.K. button 102. Thus, the information providing request is transmitted from the vendor terminal 17 to the center server 15.

If the information providing request is received from the vendor terminal 17 (YES in step S110), the center server 15 performs a statistical process by using the statistical processing portion 120 on the basis of search keys of the information providing request (step S120). Next, the concealment portion 121 deletes the facility specifying information from the facility information picked up by the statistical processing portion 120, and thus the facility specifying information is concealed (step S130). Then, the development reference information display screen 92 and the facility information display screen 106 are generated by the screen generation portion 122 on the basis of the actual usage situation information which is picked up by the statistical processing portion 120 and the facility information in which the facility specifying information is concealed by the concealment portion 121, and are output to the communication unit 53A. Consequently, the screens 92 and 106 are transmitted to the vendor terminal 17.

The screens 92 and 106 are displayed on the display 54C of the vendor terminal 17 and are provided so as to be viewed by the vendor 12.

The vendor 12 can indirectly understand the needs for the diagnosis support program 30 by viewing the screens 92 and 106. More specifically, it is possible to specify medical departments present in the medical facility 11 on the basis of the medical department names, tendency of diseases treated in the medical facility 11 on the basis of the number of disease-based patients, and a size of the medical facility 11 on the basis of the number of beds and the number of staff members, on the facility information display screen 106. The way of using the diagnosis support program 30 in the medical facility 11 having the above-described identity can be understood by viewing the actual usage situation information displayed on the actual usage situation information display region 96 of the development reference information display screen 92.

For example, it can be seen from the actual usage situation information which is sorted on the basis of diseases that the diagnosis support program 30 whose usage frequency is higher than that of other programs matches the needs of the medical facility 11 which treats a lot of patients having the diseases. Therefore, this can be used as a model of development of the diagnosis support program 30 in the future. In addition, for example, in the actual usage situation information which is sorted on the basis of areas, in a case where there is a disease for which a usage frequency of the diagnosis support program 30 is higher than that for other diseases, a target disease of the diagnosis support program 30 which is necessary in the area can be specified, and thus it becomes easier to establish development guidelines when the diagnosis support program 30 is developed for each area.

In a case where the diagnosis support program 30 is used frequently in a usage medical department, a usage disease, and a purpose of use, which are different from a target medical department, a target disease, and usage recommended by the vendor 12 side, it is understood that the development guidelines of the diagnosis support program 30 in the vendor 12 do not match the needs, that is, the way of use which is different from the recommendation matches the needs, and thus the development guidelines can be corrected. The target medical department, the target disease, and the usage may be displayed in the actual usage situation information display region 96 so as to be checked through comparison with a usage medical department, a usage disease, and a purpose of use.

Since the facility specifying information is concealed, the facility specifying information is not displayed on the facility information display screen 106. For this reason, privacy of the medical facility 11 is protected. In a case where the facility specifying information is not concealed but is displayed on the facility information display screen 106, a problem may occur in which there is a vendor 12 which sells the diagnosis support program 30 or inquires about the diagnosis support program 30 to or of the medical facility 11, and this is troublesome in the medical facility 11, but such a problem cannot occur in the present embodiment.

Since the statistical process is performed on the actual usage situation information and the facility information, it is possible to provide development reference information in which an intention of the vendor 12 is reflected.

Regarding a timing for concealing the facility specifying information, for example, the facility specifying information may be excluded when the facility information display screen 106 is generated. When the facility information is collected by the information collecting unit 112, facility information from which the facility specifying information is excluded and is provided as development reference information may be stored in the facility information DB 36 separately from the facility information including the facility specifying information. In this case, the information collecting unit 112 functions as a concealment portion. This is efficient since the concealment portion 121 is not required to be operated when the development reference information is provided.

The facility specifying information may be made not be viewable by performing screen processing on the facility information display screen 106, for example, by painting out the facility specifying information or converting the facility specifying information into any meaningless text. In this case, the screen generation portion 122 functions as a concealment portion.

Although the second or third medical area or the countryside has been exemplified as an area selected in the pull-down menu 100, in a case where the first medical area which is set in the units of a single city, a single town, and a single village, or an area having a narrower target section is used as an option, the number of medical facilities 11 having a relatively large size is limited and is thus narrowed down to a single medical facility 11 depending on cases. In this case, information regarding a size of the medical facility is also preferably concealed as the facility specifying information in order to prevent the medical facility 11 from being specified.

Instead of the facility information display screen 106 being displayed on the development reference information display screen 92 in a pop-up form, the facility information and the actual usage situation information may be displayed in the actual usage situation information display region 96 together.

In the above-described first embodiment, a description has been made of an aspect in which the actual usage situation information output unit 64 is built into the CPU 52B of the facility terminal 16, and the actual usage situation information is automatically transmitted by the facility terminal 16, but there may be a configuration in which a transmission request for the actual usage situation information is transmitted to the facility terminal 16 from the center server 15 every month, and the facility terminal 16 transmits the actual usage situation information to the center server 15 in response to the transmission request.

The facility information may include items related to a treatment result item of the medical facility 11 as illustrated in FIG. 19 in addition to or instead of the respective items exemplified in the first embodiment. The items related to the treatment result include the monthly average number of patients, area share, the average number of disease-based hospitalization days, and the number of treatment period-based patients. The monthly average number of patients is an average value of the number of patients treated in the medical facility 11 for one month. The area share is a ratio of the number of patients treated in the corresponding medical facility 11 to the number of patients treated in all medical facilities 11 in an area in which the medical facility 11 is present. For example, in a case where the number of patients treated in all medical facilities of the area is 10000, and the number of patients treated in the corresponding medical facility 11 is 2500, the area share is 25% as exemplified.

It is understood that, if the monthly average number of patients is larger, and the area share is higher, the medical facility 11 is selected by the patients. In other words, it is understood that a medical level of the medical facility 11 is high on the basis of the monthly average number of patients or the area share. In addition, it is understood that, if the monthly average number of patients is larger, and the area share is higher, the medical facility 11 is a center in the area. The monthly average number of patients and the area share are items indicating treatment results of the medical facility 11 and also indicating a size of the medical facility 11.

The average number of disease-based hospitalization days is called an efficiency index, and is an index obtained by totalizing the number of hospitalization days of patients treated in the medical facility 11 hitherto on the basis of diseases, and by dividing the totalized number of hospitalization days by the number of patients. It is understood that, if the average number of disease-based hospitalization days is smaller, a medical level of the medical facility 11 is higher. The number of treatment period-based patients is called a complexity index and is obtained by totalizing the number of patients treated in the medical facility 11 hitherto on the basis of treatment periods. It is understood that, if the number of patients whose treatment periods are long is larger in the number of treatment period-based patients, the medical facility 11 treats most of patients suffering from incurable diseases, and thus a medical level of the medical facility 11 is higher. The number of hospitalization days is the number of days from hospitalization of a patient to discharge thereof, and the treatment period is a period from initial visit to complete recovery.

The respective items of the treatment result excluding the area share are totalized on the medical facility 11 side every month, and are transmitted from the facility terminal 16 to the center server 15 every month. The number of hospitalization days of the average number of disease-based hospitalization days or a treatment period of the number of treatment period-based patients is specified by referring to the description of the recorded treatment data of the electronic medical chart 24. The area share is calculated every month on the center server 15 side on the basis of the number of patients treated in each medical facility 11 for one month, which is transmitted from each medical facility 11. The respective items of the treatment result are calculated every month, and thus the respective items of the treatment result change every month.

If the treatment result of the medical facility 11 is added to the facility information and is provided to the vendor 12 as the development reference information, a clearer identity of the medical facility 11 can be provided to the vendor 12. For example, a diagnosis support program 30 which is frequently used in the medical facility 11 having a considerable treatment result can be used as a model of development.

In the above-described first embodiment, a description has been made of an example in which all the items of the facility information are transmitted from the medical facility 11 to the center server 15, but some of the facility information is determined through examination in a public institution. Therefore, the facility information determined through the examination in a public institution may be acquired from the public institution instead of the medical facility 11.

As illustrated in FIG. 20, a usage result item may be added to the actual usage situation information. In a case where treatment of a patient is performed by using the diagnosis support program 30 and employing the diagnosis support information, the usage performance indicate whether the prognoses of the patients are an improvement or an deterioration, and are represented by the number of improved patients and the number of deteriorated patients as exemplified. A patient for whom the diagnosis support program 30 is used can be specified on the basis of a patient ID which is input via the activation screen, and whether a prognosis of the patient is an improvement or a deterioration can be specified on the basis of the description of the recorded treatment data of the electronic medical chart 24. For example, if the patient is discharged from hospital or completely recovers after employing the diagnosis support information, improvement is determined, and if the patient undergoes reoperation, or is re-hospitalized or dies, deterioration is determined.

The use result is totalized on the medical facility 11 side every month in the same manner as the usage frequency or the like, and is transmitted from the facility terminal 16 to the center server 15 every month. For this reason, the usage performance are also stored for each month.

If the use result is added to the actual usage situation information and is provided to the vendor 12 as the development reference information, the quality of the diagnosis support program 30 which cannot be recognized on the basis of the usage frequency can be provided to the vendor 12.

For example, if the purpose of use is “medicine side-effects determination”, and, as illustrated in FIG. 11, a medicine other than medicines used hitherto is recommended by the diagnosis support information, the number of improved patients and the number of deteriorated patients may be respectively totalized in cases where the recommended medicine is used and is not used (in cases where the diagnosis support information is employed and is not employed), and may be registered as the usage result. In the above-described way, if the number of improved patients increases when the diagnosis support information is not employed, it is understood that there is a problem in the quality of the diagnosis support program 30, and thus the diagnosis support program 30 is not helpful to diagnosis support. If the number of improved patients increases when the development reference information is employed, it is understood that the quality of the diagnosis support program 30 is good, and, as a result, it becomes easier to determine the quality of the diagnosis support program 30.

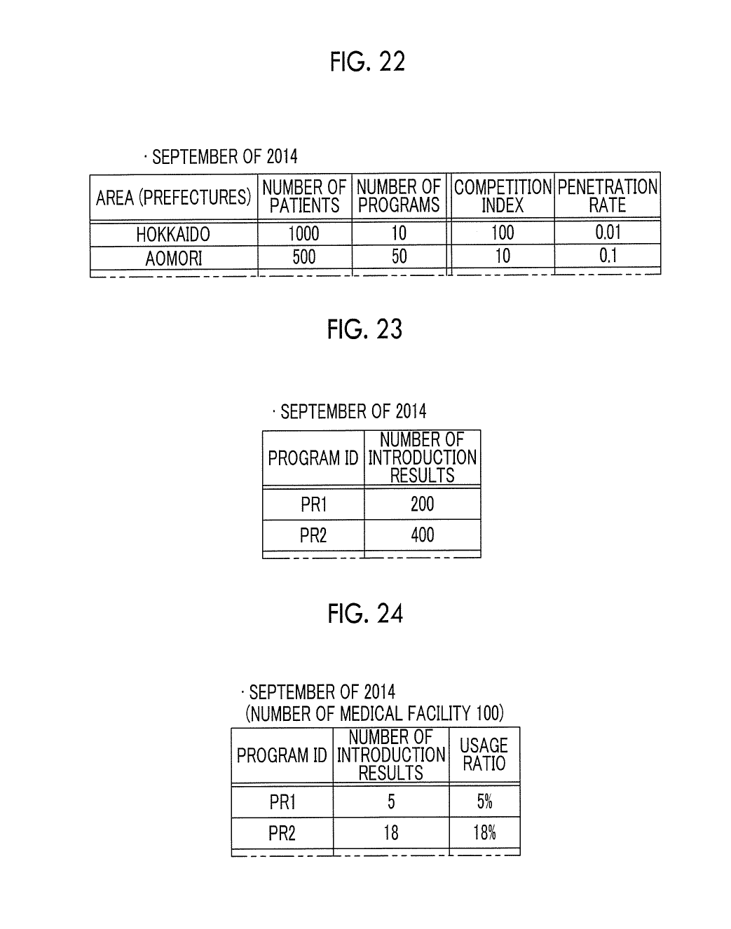

The statistical information output from the statistical processing portion 120 may include trend information indicating a trend in an actual usage situation of the diagnosis support program 30 in a plurality of medical facilities 11. The trend information is specifically a competition index or a penetration rate illustrated in FIGS. 21 and 22, the number of introduction results illustrated in FIG. 23, and a usage ratio illustrated in FIG. 24.

In FIGS. 21 and 22, the competition index is an index calculated by dividing the number of patients by the number of diagnosis support programs 30 (the number of programs). The penetration rate is calculated by dividing the number of diagnosis support programs 30 by the number of patients conversely to the competition index. In other words, the competition index and the penetration rate have a relationship of being reciprocal numbers. FIGS. 21 and 22 respectively illustrate examples of a competition index and a penetration rate in “September of 2014” on the basis of diseases and areas (prefectures). The statistical processing portion 120 calculates the number of patients and the number of diagnosis support programs 30 by using the facility information and the actual usage situation information, and calculates the competition index and the penetration rate on the basis of the calculated number of patients and number of diagnosis support programs 30.

It is understood that, if the competition index is higher (the penetration rate is lower), competition between the diagnosis support programs 30 decreases (the diagnosis support program 30 is not widespread) in the disease or the area. If such a competition index or a penetration rate is provided to the vendor 12 as the development reference information, this is helpful to marketing by referring to a disease for which the number of diagnosis support programs 30 is insufficient and an area which the vendor has an opportunity to enter. In FIGS. 21 and 22, both of the competition index and the penetration rate are calculated, but either one thereof may be calculated. The competition index or the penetration rate may be calculated not on the basis of diseases or areas but on the basis of diseases and areas.

The number of introduction results illustrated in FIG. 23 is the number of medical facilities 11 which have downloaded the diagnosis support programs 30. If the number of introduction results is provided to the vendor 12 as the development reference information, the vendor 12 can understand which diagnosis support program 30 is frequently downloaded. The number of introduction results may also be sorted on the basis of diseases or/and areas in the same manner as the competition index and the penetration rate.

The usage ratio illustrated in FIG. 24 indicates to what extent the diagnosis support program 30 is used in the medical facility 11 in which a treatment result is higher than a predetermined level. The medical facility 11 in which a treatment result is higher than the predefined level is, for example, the medical facility 11 in which the monthly average number of patients as the treatment result illustrated in FIG. 19 is equal to or larger than 1000, or the medical facility 11 in which a treatment period in the number of treatment period-based patients is equal to or longer than 30 days and the number of patients is equal to or larger than 50.

The statistical processing portion 120 picks up the medical facilities 11 in which a treatment result is higher than a predetermined level, from the facility information, and counts the number of medical facilities 11 (the number of introduction results) which have downloaded the diagnosis support program 30 for each diagnosis support program 30 among the picked-up medical facilities 11. The usage ratio is calculated by dividing the number of introduction results by the number of medical facilities 11 in which a treatment result is higher than the predefined level. FIG. 24 illustrates a case where a hundred facilities are picked up as the medical facilities 11 in which treatment result is higher than the predefined level.

If the usage ratio is provided to the vendor 12 as the development reference information, the vendor 12 can understand whether or not the diagnosis support program 30 contributes to treatment results. For example, in a case where the usage ratio is low, and thus the diagnosis support program 30 does not contribute to treatment results, it is understood that the diagnosis support program 30 has room for improvement. The usage ratios may also be sorted on the basis of diseases or/and areas.

The trend information exemplified in FIGS. 21 to 24 is trend information for a single month such as “September of 2014”, but the trend information may include time-series data indicating temporal changes of trends in actual usage situations of the diagnosis support program 30 in a plurality of medical facilities 11.

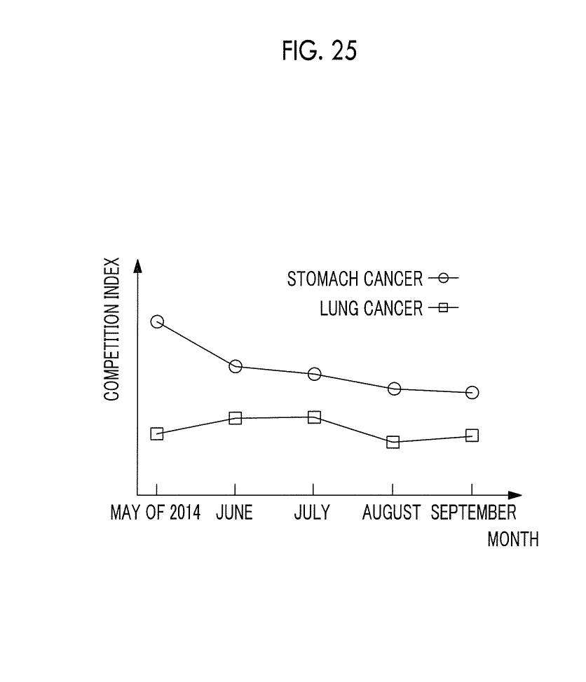

For example, as illustrated in FIG. 25, the statistical processing portion 120 creates line graphs indicating competition indexes based on diseases (in this example, “stomach cancer” and “lung cancer”) from “May of 2014” to “September of 2014”, and outputs the line graphs as the development reference information. Although not illustrated, not only the competition index but also the penetration rate, time-series data of the number of introduction results, and the usage ratio may be output as the development reference information. In addition, time-series data is not limited to the line graph exemplified in FIG. 25, and time-series data with a list form may be created. If such time-series data is provided to the vendor 12 as the development reference information, the vendor 12 can recognize changes in trends in actual use situations of the diagnosis support programs 30 and can thus use the specified changes to determine development guidelines of the diagnosis support program 30.

The trend information is created on the basis of the facility information, but since the trend information does not include the facility information, the concealment portion 121 is not operated in a case where the trend information is output.

### Second Embodiment

A term such as a medical department name or a disease name used in actual usage situation information and facility information may be expressed differently by the medical facility 11. In a case where there is a difference in an expression of the term, there is a concern that a statistical process in the statistical processing portion 120 may not be correctly performed. For example, in a case where the same medical department is expressed as a “radiological department” in a certain medical facility 11 and as a “radiological examination department” in another medical facility 11, if an option of the “radiological department” is selected in the pull-down menu 97, the medical facility 11 having the “radiological examination department” is omitted from the statistical process. Therefore, in the present embodiment, the above problem is solved by unifying expressions of terms used in the actual usage situation information and the facility information into a standard expression which is registered in advance.

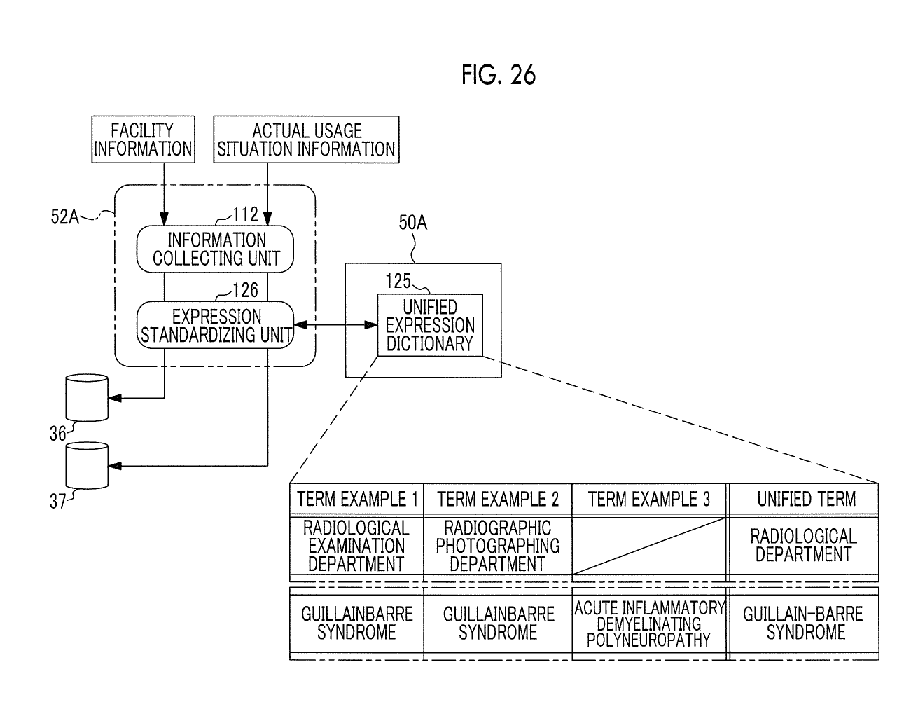

Specifically, as illustrated in FIG. 26, a unified expression dictionary 125 is stored in the storage device 50A, and an expression standardizing unit 126 which unifies expressions of terms into a standard expression on the basis of the unified expression dictionary 125 is provided at a stage following the information collecting unit 112. The unified expression dictionary 125 stores a plurality of different term examples and a single unified term corresponding to the term examples. As the unified term, for example, a medical department name which is recommended so as to be used in a receipt, an advocated medical department name which is defined according to a medical law, a disease name which is defined according to International Statistical Classification of Diseases and Related Health Problems (ICD)-10, or standard expression based on a standard master or the like such as a clinical examination master or an operation/treatment master used in a plurality of medical facilities 11 is registered.

The expression standardizing unit 126 compares a term such as a medical department name or a disease name used in the actual usage situation information and the facility information received from the information collecting unit 112 with the term examples and the unified terms of the unified expression dictionary 125. If a term which is present in the term examples and is not a unified term is present in the actual usage situation information and the facility information, the expression standardizing unit 126 converts the term into a unified term. After conversion into the unified term, the expression standardizing unit 126 stores the actual usage situation information and the facility information in the facility information list 40 of the facility information DB 36 and the actual usage situation information list 41 of the actual usage situation information DB 37, respectively. The statistical process can be accurately performed by unifying terms of the actual usage situation information and the facility information in the expression standardizing unit 126. In FIG. 26, the program storage/delivery processing unit 111 and the information providing unit 113 are not illustrated.

### Third Embodiment

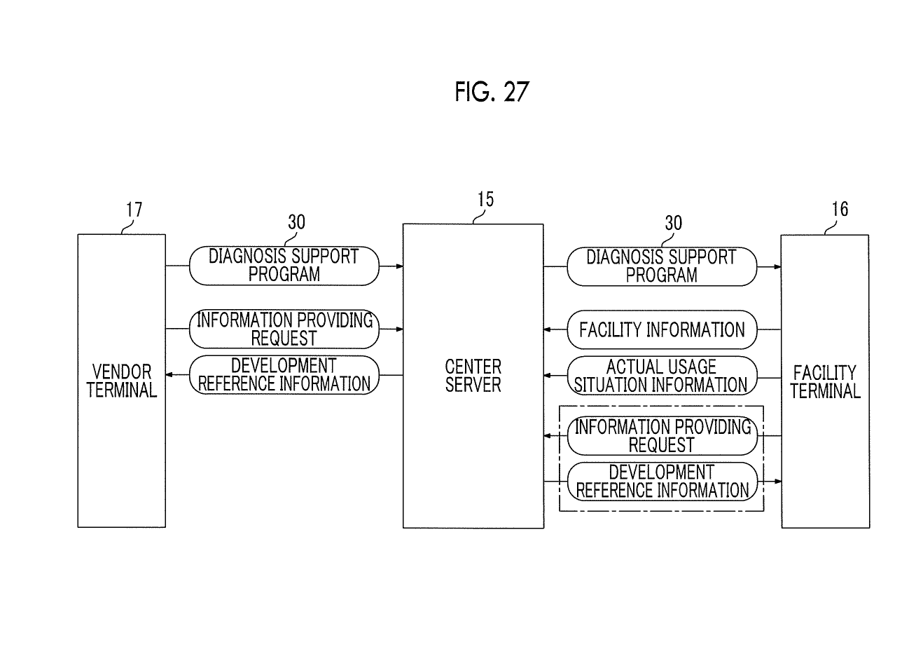

In the above-described first embodiment, a provision destination of the development reference information is limited to the vendor 12, but the development reference information may also be provided to the medical facility 11 as surrounded and indicated by a dot chain line in FIG. 27. In the above-described way, the medical facility 11 can understand a function and quality of the diagnosis support program 30 on the basis of the development reference information, and can determine whether or not the diagnosis support program 30 will be introduced after ascertaining the function and quality thereof. The diagnosis support program 30 is not sold by the vendor 12, but introduction thereof can be independently examined by the medical facility 11.

The vendor 12 provides the development reference information instead of selling the diagnosis support program 30 to the medical facility 11. For this reason, an effort to sell the diagnosis support program 30 can be returned to development of the diagnosis support program 30, and thus development of the diagnosis support program 30 can be promoted.

A provision destination of the development reference information is not limited to the medical facility 11 or the vendor 12, and may be other general users such as patients or public institutions. In this case, the information providing unit 113 provides the development reference information in response to a information providing request from a personal computer or a tablet terminal owned by a general user.

### Fourth Embodiment

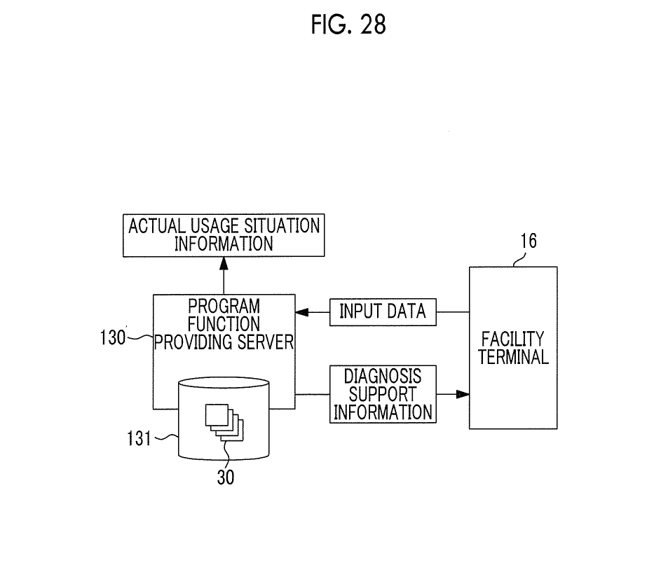

As an aspect of providing a function of the diagnosis support program 30, there is not only an aspect in which the diagnosis support program 30 is downloaded from the center server 15 to the facility terminal 16, and calculation using the diagnosis support program 30 and output of the diagnosis support information are completed in the facility terminal 16 as in the above-described first embodiment, but also an aspect illustrated in FIG. 28.

In FIG. 28, instead of downloading the diagnosis support program 30 to the facility terminal 16 and using the diagnosis support program 30 in the facility terminal 16, a program function providing server 130 is an application service provider (ASP) type server which provides only a function of the diagnosis support program 30 without downloading the diagnosis support program 30 to the facility terminal 16. The program function providing server 130 is provided with a program DB 131 which is the same as the program DB 35 of the first embodiment and which stores all diagnosis support programs 30 uploaded from the vendor terminal 17. A program control unit and an actual usage situation information output unit which are the same as the program control unit 63 and the actual usage situation information output unit 64 built into the CPU 52B of the facility terminal 16 in the first embodiment are built into a CPU.

In this case, the facility terminal 16 transmits input data of the diagnosis support program 30 to the program function providing server 130. The program function providing server 130 gives the input data from the facility terminal 16 to the diagnosis support program 30 and causes the diagnosis support program 30 to perform calculation and to output diagnosis support information. The program function providing server 130 transmits the diagnosis support information output from the diagnosis support program 30, to the facility terminal 16.

The program function providing server 130 outputs actual usage situation information. In other words, in the aspect illustrated in FIG. 28, the program function providing server 130 is a transmission source of the actual usage situation information.

The function of the program function providing server 130 may be realized by the center server 15, and the program function providing server 130 may be provided in the data center 10 separately from the center server 15. A location in which the program function providing server 130 is provided is not limited to the data center 10, and may be the medical facility 11 or the vendor 12.

### Fifth Embodiment

In the above-described first embodiment, an aspect has been exemplified in which the viewer software 60 with a specification of automatically outputting the actual usage situation information is downloaded to the facility terminal 16, but the actual usage situation information may be manually transmitted, for example, in a case of using viewer software owned by a company which is different from a company operating the data center, the viewer software having no function of automatically outputting the actual usage situation information. Then, transmission of the actual usage situation information may be forgotten, or only the development reference information may be improperly viewed without intentionally transmitting the actual usage situation information, and thus collection of the actual usage situation information may be delayed. Therefore, in the present embodiment, in a case where the actual usage situation information which is manually transmitted from a transmission source is acquired, a situation of collecting the actual usage situation information in the information collecting unit 112 is monitored, and a countermeasure is taken in order to prevent collection of the actual usage situation information from being delayed.

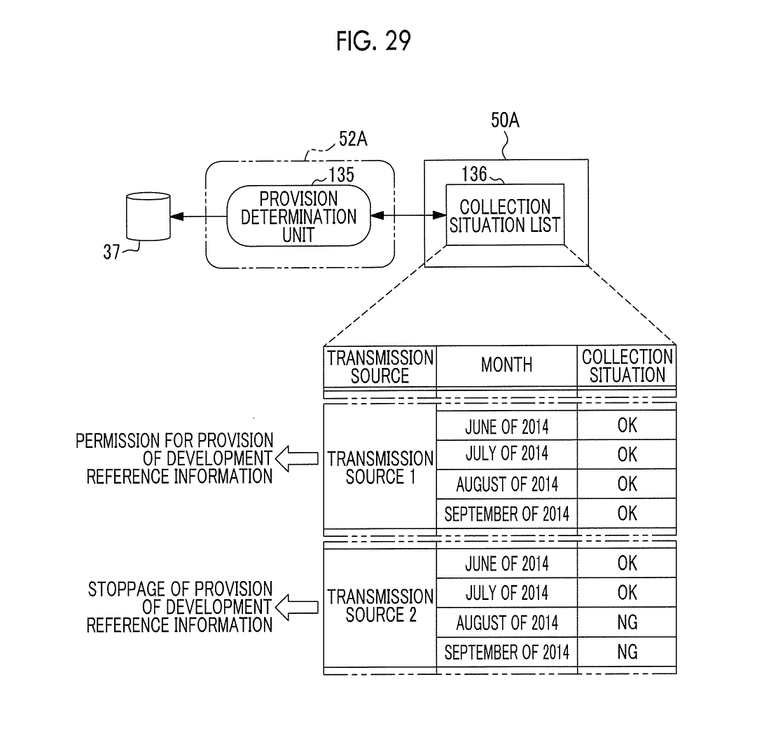

Specifically, as illustrated in FIG. 29, a provision determination unit 135 is provided in the CPU 52A. The provision determination unit 135 accesses the actual usage situation information list 41 of the actual usage situation information DB 37 every month so as to monitor a collection situation of the actual usage situation information. The provision determination unit 135 creates a collection situation list 136 which records the collection situation every month for each transmission source on the basis of monitoring results of the collection situation and stores the collection situation list 136 in the storage device 50A. The provision determination unit 135 determines that the development reference information will not be provided to a transmission source which has not transmitted the actual usage situation information, for a predetermined period of time, for example, for two months in the collection situation list 136.

In FIG. 29, a transmission source I has transmitted the actual usage situation information without delay and is thus permitted to receive provision of the development reference information, and a transmission source 2 has not transmitted the actual usage situation information for two months and thus is not permitted to receive provision of the development reference information.

As mentioned above, it is determined whether or not the development reference information will be provided depending on the collection situation of the actual usage situation information. That is, it is determined that the development reference information will not be provided to a transmission source which delays transmission of the actual usage situation information for a predetermined period of time so that a penalty is imposed on the transmission source which fails to transmit the actual usage situation information. Thus, even in a case where the actual usage situation information is manually transmitted, the actual usage situation information can be collected without delay. In FIG. 29, the respective functional units of the first embodiment are not illustrated.

In the above-described first embodiment, the actual usage situation information output unit 64 of the facility terminal 16 which is a transmission source outputs information which is generated on the basis of the log file 65, as the actual usage situation information, but the log file 65 may be output as the actual usage situation information.

In a case where, as in the first embodiment, the viewer software 60 for operating a plurality of diagnosis support programs on the single common medical examination data display screen 70 along with display of medical examination data is provided from the center server 15 to the facility terminal 16, the center server 15 may perform an operation verification test for verifying whether or not the diagnosis support program 30 uploaded from the vendor terminal 17 is operating without any problems.

A result of the operation verification test performed on the diagnosis support program 30 may be registered in the program list 39, and, for example, in a case where the facility terminal 16 selects the diagnosis support program 30 to be downloaded, the diagnosis support program 30 which has been determined as being problematic in the operation verification test may be unselectable, and, alternatively, a URL link to a website of the vendor 12 or contact details such as a telephone number may be displayed.

As a charging system of the medical examination support system 2, for example, regarding the medical facility 11, a charging amount is determined on the basis of a usage amount of the diagnosis support program 30, such as the number of downloaded diagnosis support programs 30 or a usage frequency thereof in addition to a basic charge. Regarding the vendor 12, a charging amount is determined on the basis of the number of times of viewing the development reference information. Some fees collected from the medical facilities 11 may be distributed to the vendors 12 according to the number of introduction results or the like of the diagnosis support program 30. As illustrated in FIG. 27, in a case where the development reference information is also provided to the medical facility 11, fees related to viewing of the development reference information may also be collected from the medical facility 11.

The information collecting unit 112 may be divided into an information collecting unit for collecting facility information and an information collecting unit for collecting actual usage situation information. The sales mediation function (the program storage/delivery processing unit 111) and the development reference information providing function (the information collecting unit 112 and the information providing unit 113) of the diagnosis support program 30 may be distributed to two servers.

A form of providing the development reference information is not limited to screen delivery using the web exemplified in the above-described first embodiment. For example, there may be a form in which a DB storing a file in which the development reference information is recorded is provided, access rights to the DB are given to the medical facility 11 or the vendor 12, and the file of the development reference information may be read from the DB. There may be a form in which the file of the development reference information may be automatically transmitted to the facility terminal 16 or the vendor terminal 17 by using a well-known file transfer protocol such as File Transfer Protocol over SSL/TLS (FTPS). An electronic mail may be used instead of the file transfer protocol.

A period for transmitting the actual usage situation information is not limited to one month exemplified in the above-described first embodiment, and may be one day, one week, or one year. The actual usage situation information may be transmitted whenever the diagnosis support program 30 is used.

The diagnosis support program 30 may be directly downloaded from the vendor terminal 17 to the facility terminal 16 without using the center server 15.

A patient name of a patient for whom the diagnosis support program 30 is used may be included in the actual usage situation information. In this case, the patient name is preferably concealed in order to protect the patient's privacy.

The present invention is not limited to the above-described respective embodiments, and may employ various configurations without departing from the spirit of the present invention. The above-described various embodiments or various modification examples may be combined with each other as appropriate. The present invention can be expressed not only as a program but also as a storage medium storing the program.

What is claimed is:

1. A diagnosis support program development promoting apparatus for promoting development of a diagnosis support program which outputs diagnosis support information by using medical examination data of a patient, the apparatus comprising:
an information collecting unit that collects actual usage situation information regarding an actual usage situation of the diagnosis support program in a medical facility, and facility information regarding the medical facility, including facility specifying information for specifying the medical facility, for each medical facility;
a concealment unit that conceals the facility specifying information; and
an information providing unit that provides development reference information including the actual usage situation information and the facility information in which the facility specifying information is concealed, in response to an information providing request.

2. The diagnosis support program development promoting apparatus according to claim 1,
wherein the actual usage situation information includes at least one of a usage frequency, a purpose of use, and usage performance of the diagnosis support program, and a medical department using the diagnosis support program, and a disease for which the diagnosis support program is used.

3. The diagnosis support program development promoting apparatus according to claim 1,
wherein the facility information includes at least one of a size of the medical facility, a medical department provided in the medical facility, an area in which the medical facility is present, diseases treated in the medical facility, and treatment results of the medical facility based on the number of patients treated in the medical facility.

4. The diagnosis support program development promoting apparatus according to claim 3,
wherein the treatment result includes at least one of the monthly average number of patients of the medical facility, area share indicating a proportion of the number of patients treated in the medical facility in the area in which the medical facility is present, the average number of disease-based hospitalization days of the medical facility, and the number of treatment period-based patients of the medical facility.

5. The diagnosis support program development promoting apparatus according to claim 1,
wherein the facility information includes a name of the medical facility, and the facility specifying information is at least the name.

6. The diagnosis support program development promoting apparatus according to claim 1, further comprising:
a statistical processing unit that performs a statistical process on the actual usage situation information and the facility information to output statistical information,
wherein the information providing unit provides the statistical information as the development reference information.

7. The diagnosis support program development promoting apparatus according to claim 6,
wherein the statistical information includes trend information indicating trends in actual usage situations of the diagnosis support program in a plurality of the medical facilities.

8. The diagnosis support program development promoting apparatus according to claim 7,
wherein the statistical processing unit performs a sorting process of sorting the actual usage situation information and the facility information, or the trend information on the basis of diseases or/and areas, as the statistical process, and outputs the information having undergone the sorting process as the statistical information.

9. The diagnosis support program development promoting apparatus according to claim 7,
wherein the trend information includes at least one of a competition index calculated by dividing the number of patients by the number of the diagnosis support programs or/and a penetration rate calculated by dividing the number of the diagnosis support programs by the number of patients, the number of introduction results of the diagnosis support program, and a usage ratio of the diagnosis support program of the medical facility in which a treatment result is higher than a predefined level.

10. The diagnosis support program development promoting apparatus according to claim 6, further comprising:
an expression standardizing unit that unifies expressions of terms used in the actual usage situation information and the facility information into a standard expression which is registered in advance.

11. The diagnosis support program development promoting apparatus according to claim 1,
wherein the information providing unit provides the development reference information in response to the information providing request from a vendor of the diagnosis support program.

12. The diagnosis support program development promoting apparatus according to claim 1,
wherein the information providing unit provides the development reference information in response to the information providing request from the medical facility.

13. The diagnosis support program development promoting apparatus according to claim 1,
wherein the information collecting unit acquires the actual usage situation information which is automatically transmitted from a transmission source.

14. The diagnosis support program development promoting apparatus according to claim 1,
wherein the information collecting unit acquires the actual usage situation information which is manually transmitted from a transmission source.

15. The diagnosis support program development promoting apparatus according to claim 14, further comprising:
a provision determination unit that determines whether or not the development reference information will be provided to the transmission source depending on a collection situation of the actual usage situation information in the information collecting unit.

16. The diagnosis support program development promoting apparatus according to claim 13,
wherein the transmission source is a facility terminal which uses the diagnosis support program in the medical facility, or a program function providing server which receives input data from the facility terminal, causes the diagnosis support program to perform calculation on the basis of the received input data, and transmits the diagnosis support information which is output as a result of the calculation to the facility terminal.

17. A non-transitory computer readable recording medium storing an operation program for a diagnosis support program development promoting apparatus for promoting development of a diagnosis support program which outputs diagnosis support information by using medical examination data of a patient, the program causing a computer to execute:
an information collecting function of collecting actual usage situation information regarding an actual usage situation of the diagnosis support program in a medical facility, and facility information regarding the medical facility, including facility specifying information for specifying the medical facility, for each medical facility;
a concealment function of concealing the facility specifying information; and
an information providing function of providing development reference information including the actual usage situation information and the facility information in which the facility specifying information is concealed, in response to an information providing request.

18. A diagnosis support program development promoting system comprising:
a diagnosis support program development promoting server that promotes development of a diagnosis support program which outputs diagnosis support information by using medical examination data of a patient;
a facility terminal of a medical facility that uses the diagnosis support program; and
a network that connects the diagnosis support program development promoting server to the facility terminal in a communicable manner,
wherein the diagnosis support program development promoting server includes
an information collecting unit that collects actual usage situation information regarding an actual usage situation of the diagnosis support program in the medical facility, and facility information regarding the medical facility, including facility specifying information for specifying the medical facility, for each medical facility;
a concealment unit that conceals the facility specifying information; and
an information providing unit that provides development reference information including the actual usage situation information and the facility information in which the facility specifying information is concealed, in response to an information providing request.

19. The diagnosis support program development promoting system according to claim 18, wherein the diagnosis support program is downloaded to the facility terminal, and the actual usage situation information is transmitted from the facility terminal to the diagnosis support program development promoting server.

20. The diagnosis support program development promoting system according to claim 18, further comprising:
a program function providing server that receives input data from the facility terminal, causes the diagnosis support program to perform calculation on the basis of the received input data, and transmits the diagnosis support information which is output as a result of the calculation to the facility terminal,
wherein the actual usage situation information is transmitted from the program function providing server to the diagnosis support program development promoting server.
